(19) United States
(12) Patent Application Publication
(10) Pub. No.: US 2025/0184729 A1
(43) Pub. Date: Jun. 5, 2025

(54) NETWORK INITIATED PRIMARY AUTHENTICATION

(71) Applicant: Lenovo (Singapore) Pte. Limited, Singapore (SG)

(72) Inventors: Sheeba Backia Mary Baskaran, Friedrichsdorf (DE); Andreas Kunz, Ladenburg (DE)

(73) Assignee: Lenovo (Singapore) Pte. Limited, Singapore (SG)

(21) Appl. No.: 18/852,409

(22) PCT Filed: Mar. 27, 2023
(86) PCT No.: PCT/IB2023/053019

§ 371 Date: Sep. 27, 2024

Related U.S. Application Data
(60) Provisional application No. 63/324,241, filed on Mar. 28, 2022.

(51) Int. Cl. H04W 12/06

(52) U.S. Cl. CPC H04W 12/06

(57) ABSTRACT

Various aspects of the present disclosure relate to an authentication server function (AUSF) that receives an authentication request from a security anchor function (SEAF), and transmits a data request for authentication data to unified data management (UDM). The AUSF can receive the authentication data from the UDM for primary authentication, and set an expiration time for security information associated with the primary authentication being successful. The AUSF can then transmit an authentication message of authentication information that includes the security information and the expiration time to an authentication and key management for applications (AKMA) anchor function (AAnF) that registers the expiration time. The AUSF can also initiate reauthentication based at least in part on expiry of the authentication information.

### RELATED APPLICATION

This application claims priority to U.S. Provisional Application Ser. No. 63/324,241 filed Mar. 28, 2022 entitled “Network Initiated Primary Authentication,” the disclosure of which is incorporated by reference herein in its entirety.

### TECHNICAL FIELD

The present disclosure relates to wireless communications, and more specifically to network initiated primary authentication.

### BACKGROUND

A wireless communications system may include one or multiple network communication devices, such as base stations, which may be otherwise known as an eNodeB (eNB), a next-generation NodeB (gNB), core network functions (CNFs), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

In a 5G system, the primary authentication of a UE generates an authentication server function (AUSF) key (i.e., K_{AUSF}) that is shared between the UE and a home network. The purpose of the primary authentication and key agreement procedures is to enable mutual authentication between the UE and the network, and provide keying material that can be used between the UE and the serving network in subsequent security procedures. A successful primary authentication of a UE allows for the generation of the K_{AUSF}. In 5G, the K_{AUSF} is a long-term key, given that UEs may be communicatively linked to a network for a long duration without refreshing the K_{AUSF}. In this long duration scenario, the UE may not refresh the K_{AUSF}.

### SUMMARY

The present disclosure relates to methods, apparatuses, and systems that support network initiated primary authentication. By utilizing the described techniques, a home network can trigger primary authentication or reauthentication, taking into consideration factors such as the lifetime and/or expiry time related to the primary authentication (such as authentication vector or AUSF key), steering of roaming (SoR) counter wrap, and UE parameter update (UPU) counter wrap. Further the described solutions enable binding the lifetime or expiration time of the authentication and key management for applications (AKMA) key (K_{AKMA}) and the application function key (K_{AF}) with the lifetime or expiration time of the primary authentication and the associated AUSF key (K_{AUSF}). This prevents service failure related to application function key expiry, and implicitly enforces the UE and AKMA anchor function (AAnF) to use the new AKMA key related to successful primary authentication or reauthentication following an application function key expiry.

Aspects of the disclosure are directed to enabling home network triggered primary authentication and/or reauthentication, and the handling of related security keys for lifetime and/or expiry time. Aspects of the disclosure are also directed to setting the application function key expiry taking into consideration the AKMA key (K_{AKMA}) expiry and/or lifetime. Aspects of the disclosure are also directed to providing the AUSF and/or the access and mobility management function (AMF) with authentication related lifetime and/or expiration time by the unified data management (UDM). A UE and the network can successfully reauthenticate and establish NAS security and AS security based on a new security context (K_{AUSF} and K_{SEAF}) derived from a successful primary authentication or reauthentication.

Some implementations of the method and apparatuses described herein may include wireless communication at a device (e.g., an apparatus implemented as an (AUSF), and the device receives an authentication request from a security anchor function (SEAF), and transmits a data request for authentication data to UDM. The AUSF can receive the authentication data from the UDM for primary authentication, and set an expiration time for security information associated with the primary authentication being successful. The AUSF can then transmit an authentication message of authentication information that includes the security information and the expiration time to an AKMA anchor function (AAnF) that registers the expiration time. The AUSF can also initiate reauthentication based at least in part on expiry of the authentication information.

In some implementations of the method and apparatuses described herein, the authentication information can include a SoR counter wrap around and/or a UPU counter wrap around, and the AUSF initiates the reauthentication based on the expiry of the SoR counter wrap around or the UPU counter wrap around. The authentication information can include an AUSF key (K_{AUSF}) lifetime, and the AUSF initiates the reauthentication based on the expiry of the K_{AUSF} lifetime. The AUSF may also initiate the reauthentication based on a reauthentication policy by a home network operator. The security information can include an AUSF key (K_{AUSF}), an AKMA key (K_{AKMA}), an authentication vector, a primary authentication status, and/or a primary authentication result. The AUSF can transmit the authentication message to the AAnF as an AKMA key (K_{AKMA}) register request that includes a UE subscription permanent identifier (SUPI), an AKMA key identifier (A-KID), a K_{AKMA}, and/or an expiry time of the K_{AKMA}. The AUSF can transmit an authentication response to the SEAF, the authentication response including an indication of authentication success, a SUPI, an AKMA key (K_{AKMA}), and/or an expiry time of the primary authentication. The authentication data received from the UDM includes an authentication vector (AV), an expiry time of the AV, an expiry time of the primary authentication, a SUPI, an AKMA indication, and/or a routing indicator.

Further, the AUSF can transmit an authentication trigger request to the AMF/SEAF to initiate reauthentication, the authentication trigger request including a SUPI and/or an indication that reauthentication is required. The AUSF can also receive an acknowledgement (ACK) from the AMF/SEAF in response to an authentication trigger request transmitted to the AMF/SEAF. The AUSF can transmit an authentication trigger request to the UDM, the authentication trigger request including a SUPI, an indication that reauthentication is required, and/or an indication as to a cause of the authentication trigger request. The cause of the authentication trigger request may be an expired AUSF key (K_{AUSF}), a counter wrap expiry indication, and/or an authentication lifetime expired indication. The AUSF can receive an ACK from the UDM in response to an authentication trigger request transmitted to the UDM. The AUSF can also receive authentication result information from the UDM, the authentication result information including an expiration time and an authentication result confirmation.

Some implementations of the method and apparatuses described herein may include wireless communication at a device (e.g., an apparatus implemented as an AAnF), and the device receives an authentication message from an AUSF, the authentication message comprising authentication information including at least security information and an expiration time. The AAnF maintains the security information and the expiration time, the security information including at least an AKMA key (K_{AKMA}). The AAnF can transmit a register response to the AUSF as a confirmation of the AKMA key (K_{AKMA}) being registered.

In some implementations of the method and apparatuses described herein, the authentication message is received from the AUSF as an AKMA key (K_{AKMA}) register request, and includes a SUPI, an AKMA key identifier (A-KID), the K_{AKMA}, and/or an expiry time of the K_{AKMA}. The AAnF can derive an application function (AF) key (K_{AF}) from the AKMA key (K_{AKMA}), and set a K_{AF} expiry time based on one of the expiration time or a lifetime of the K_{AKMA}. The AAnF can receive a key request for the AKMA key (K_{AKMA}) from an application function (AF), and transmit a waiting time response to the AF based on a determination that the AKMA key (K_{AKMA}) has expired. The AAnF can receive a key request for the AKMA key (K_{AKMA}) from an application function (AF), the key request comprising an AKMA key identifier (A-KID), determine whether a stored AKMA key expiration time or lifetime has expired for the associated A-KID, and one of determine to refresh the AF key if the stored AKMA key expiration time or lifetime has not expired; or determine not to refresh the AF Key if the stored AKMA key expiration time or lifetime has expired, and wait for the new AKMA key to be provided by the AUSF.

Some implementations of the method and apparatuses described herein may include wireless communication at a device (e.g., an apparatus implemented as an AMF/SEAF), and the device receives a registration request from a UE, and transmits an authentication request to an AUSF. The AMF/SEAF receives an authentication response from the AUSF, the authentication response including an indication of authentication success and an expiration time and/or a lifetime of authentication duration. The AMF/SEAF can maintain the expiration time and/or the lifetime of the authentication duration along with a SUPI configured to trigger a reauthentication.

In some implementations of the method and apparatuses described herein, the AMF/SEAF can store the expiration time and/or the lifetime of authentication duration, and initiate to trigger the reauthentication of the UE based on the expiration time and/or the lifetime of the authentication duration. The AMF/SEAF can transmit the expiration time and/or lifetime of authentication duration to a target AMF in response to receiving a handover required message, the target AMF configured to store the expiration time and/or the lifetime of authentication duration along with the SUPI and UE context, usable to invoke the reauthentication. The AMF/SEAF can receive an authentication trigger request from the AUSF to initiate reauthentication, the authentication trigger request including a SUPI and/or an indication that reauthentication is required, and transmit an ACK to the AUSF in response to the authentication trigger request.

Some implementations of the method and apparatuses described herein may include wireless communication at a device (e.g., an apparatus implemented as UDM), and the device receives a data request for authentication data from an AUSF, and transmits the authentication data to the AUSF for primary authentication. The UDM can receive an authentication trigger request from the AUSF, the authentication trigger request including a SUPI, an indication that reauthentication is required, and/or an indication as to a cause of the authentication trigger request. The UDM can transmit an ACK to the AUSF in response to the authentication trigger request.

In some implementations of the method and apparatuses described herein, the authentication data transmitted to the AUSF includes an AV, an expiry time of the AV, an expiry time of the primary authentication, the SUPI, an AKMA indication, and/or a routing indicator. The cause of the authentication trigger request may include an expired AUSF key (K_{AUSF}), a counter wrap expiry indication, and/or an authentication lifetime expired indication. The UDM can determine whether the authentication trigger request is valid based on an expiration indication of expiry time and/or a lifetime duration as configured for an AV. The UDM can determine whether the authentication trigger request is valid based on an expiration indication of expiry time, a lifetime duration for primary authentication associated with the SUPI, and/or a lifetime duration for primary reauthentication associated with the SUPI. The UDM can store SoR data and/or UPU data until a successful primary reauthentication is completed, and reinitiate the SoR and/or the UPU. The UDM can store an authentication status of the UE and set an authentication expiration time for the UE. The UDM can transmit an authentication result confirmation response to the AUSF, the authentication result confirmation response including an expiry time and/or lifetime duration associated with primary authentication. The UDM can transmit a registration response result to an AMF, the registration response result including an expiry time and/or lifetime duration associated with primary authentication.

### BRIEF DESCRIPTION OF THE DRAWINGS

Various aspects of the present disclosure for network initiated primary authentication are described with reference to the following Figures. The same numbers may be used throughout to reference like features and components shown in the Figures.

FIG. 1 illustrates an example of a wireless communications system that supports network initiated primary authentication in accordance with aspects of the present disclosure.

FIG. 2 illustrates an example of authentication and key management for applications anchor key (K_{AKMA}) refresh conventional signaling as related to network initiated primary authentication in accordance with aspects of the present disclosure

FIG. 3 illustrates an example of phase-1 signaling for factors considered by the AUSF to trigger primary reauthentication, which supports network initiated primary authentication in accordance with aspects of the present disclosure.

FIG. 4 illustrates an example of phase-2 signaling as a procedure for AUSF triggered reauthentication from a home network, which supports network initiated primary authentication in accordance with aspects of the present disclosure.

FIG. 5 illustrates an example of setting the expiry time and/or lifetime for an application function key that supports network initiated primary authentication in accordance with aspects of the present disclosure.

FIG. 6 illustrates an example of providing authentication related lifetime and/or expiration time after a successful primary authentication that supports network initiated primary authentication in accordance with aspects of the present disclosure.

FIG. 7 illustrates an example block diagram of components of a device (e.g., implemented as an AUSF) that supports network initiated primary authentication in accordance with aspects of the present disclosure.

FIG. 8 illustrates an example block diagram of components of a device (e.g., implemented as a AAnF, an AMF/SEAF, or UDM) that supports network initiated primary authentication in accordance with aspects of the present disclosure.

FIGS. 9-16 illustrate flowcharts of methods that support network initiated primary authentication in accordance with aspects of the present disclosure.

### DETAILED DESCRIPTION

Implementations of network initiated primary authentication are described, such as related to a UE and the network successfully reauthenticating. By utilizing the described techniques, a home network can trigger primary authentication or reauthentication, taking into consideration factors such as the lifetime and/or expiry time related to the primary authentication (such as authentication vector or AUSF key), SoR counter wrap, and UPU counter wrap. Further the described solutions enable binding the lifetime or expiration time of the AKMA key (K_{AKMA}) and the application function key (K_{AF}) with the lifetime or expiration time of the primary authentication and the associated AUSF key (K_{AUSF}). This prevents service failure related to application function key expiry, and implicitly enforces the UE and AKMA anchor function (AAnF) to use the new AKMA key related to successful primary authentication or reauthentication following an application function key expiry.

In a 5G system, the primary authentication of a UE generates an authentication server function (AUSF) key (i.e., K_{AUSF}) that is shared between the UE and a home network. The purpose of the primary authentication and key agreement procedures is to enable mutual authentication between the UE and the network, and provide keying material that can be used between the UE and the serving network in subsequent security procedures. A successful primary authentication of a UE allows for the generation of the K_{AUSF}. In 5G, the K_{AUSF} is a long-term key, given that UEs may be communicatively linked to a network for a long duration without refreshing the K_{AUSF}. In this long duration scenario, the home network does not have a mechanism to trigger reauthentication for the UE to refresh the K_{AUSF}. Given that AKMA keys, security for steering of roaming (SOR), and UE parameter update relies on the AUSF key, using the same AUSF key without any reauthentication for a longer period of time is not desirable.

Aspects of the present disclosure include solutions to enable the home network to trigger primary authentication or reauthentication, taking into consideration factors such as the lifetime and/or expiry time related to the primary authentication (such as authentication vector or AUSF key), SoR counter wrap, and UPU counter wrap. Further the described solutions enable binding the lifetime or expiration time of the AKMA key (K_{AKMA}) and the application function key (K_{AF}) with the lifetime or expiration time of the primary authentication and the associated AUSF key (K_{AUSF}). This prevents service failure related to application function key expiry, and implicitly enforces the UE and AKMA anchor function (AAnF) to use the new AKMA key related to successful primary authentication or reauthentication following an application function key expiry.

Aspects of the disclosure are directed to enabling home network triggered primary authentication and/or reauthentication, and the handling of related security keys for lifetime and/or expiry time. Aspects of the disclosure are also directed to setting the application function key expiry taking into consideration the AKMA key (K_{AKMA}) expiry and/or lifetime. Aspects of the disclosure are also directed to providing the AUSF and/or the AMF with authentication related lifetime and/or expiration time by the UDM. A UE and the network can successfully reauthenticate and establish NAS security and AS security based on a new security context (K_{AUSF} and K_{SEAF}) derived from a successful primary authentication or reauthentication.

Aspects of the present disclosure are described in the context of a wireless communications system. Aspects of the present disclosure are further illustrated and described with reference to device diagrams and flowcharts that relate to network initiated primary authentication.

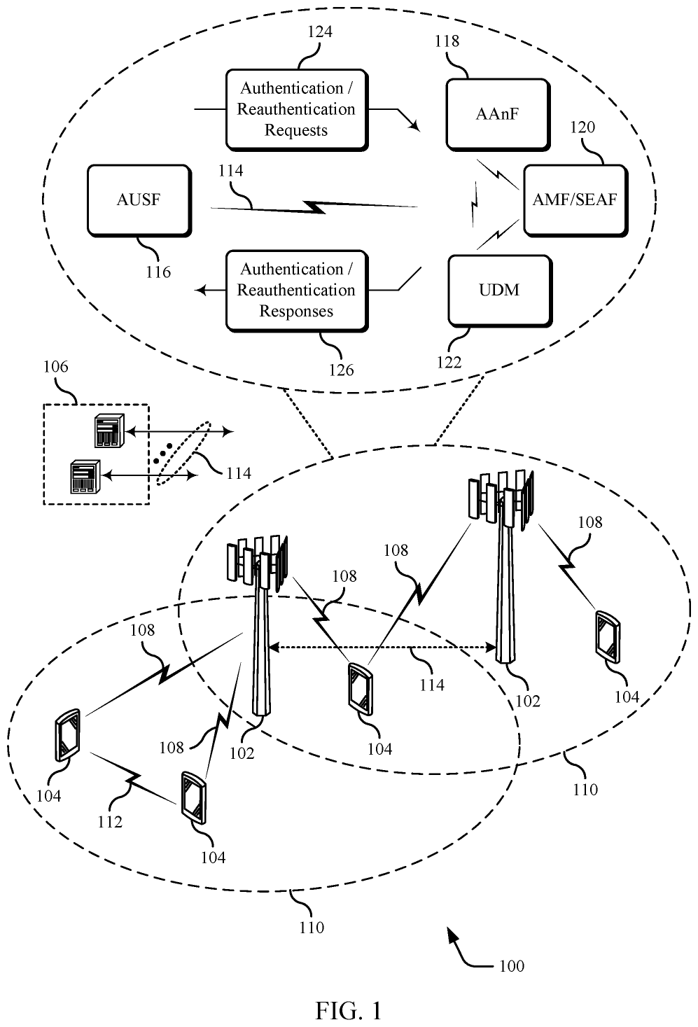

FIG. 1 illustrates an example of a wireless communications system 100 that supports network initiated primary authentication in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (LAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an AMF), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of a device 116 (e.g., implemented as an AUSF), as well as an AAnF 118, an AMF/SEAF 120, and/or a UDM 122, are operable to implement various aspects of network initiated primary authentication, as described herein. Any one or more of the devices (e.g., implemented as the AUSF 116, AAnF 118, AMF/SEAF 120, or UDM 122) may be implemented in the wireless communications system 100 as any type of network device or network entity performing procedures for network initiated primary authentication. For instance, the AUSF 116 can communicate or transmit any type of primary authentication and/or reauthentication requests, signaling, messages, information, and the like to any one or more of the AAnF 118, AMF/SEAF 120, or UDM 122 via a network communication link 114. The AAnF 118, AMF/SEAF 120, or UDM 122 may also communicate any of the authentication and/or reauthentication communications and requests 124 between any of the other devices. Any one or more of the AAnF 118, AMF/SEAF 120, or UDM 122 may also respond with any type of authentication and/or reauthentication responses, signaling, messages, information, and the like to the AUSF 116. Further, the AAnF 118, AMF/SEAF 120, or UDM 122 may communicate any of the authentication and/or reauthentication communications and responses 126 between any of the other devices. Accordingly, the AUSF 116 can receive and process the authentication and/or reauthentication responses 126 to facilitate a UE and the network successfully reauthenticating and establishing security based on a new security context (K_{AUSF} and K_{SEAF}) derived from a successful primary authentication or reauthentication.

In a 5G system, the primary authentication of a UE generates an AUSF key (i.e., K_{AUSF}) that is shared between the UE and a home network. The purpose of the primary authentication and key agreement procedures is to enable mutual authentication between the UE and the network, and provide keying material that can be used between the UE and the serving network in subsequent security procedures. A successful primary authentication of a UE allows for the generation of the K_{AUSF}. In 5G, the K_{AUSF} is a long-term key, given that UEs may be communicatively linked to a network for a long duration without refreshing the K_{AUSF}. In this long duration scenario, the home network does not have a mechanism to trigger reauthentication for the UE to refresh the K_{AUSF}. Additionally, there are scenarios, where the security aspects related to SoR, UPU, and AKMA depends on AUSF key. In SoR and UPU, reusing the same AUSF key after a counter wrap can lead to the same MAC generation at the UE, which is not desired. Also, in the AKMA feature, the AKMA key refresh depends on the primary authentication, but the application function (AF) key refresh is taken care by the Ua protocol, and the AF key expiry time is independent of the AKMA key. This can result in the usage of application keys when their root key (i.e., AKMA Key (K_{AKMA}) and AUSF Key (K_{AUSF}) from a previous successful primary authentication) is no longer in use, which is not an acceptable security principle. Notably, as in any security key derivation, the child key lifetime should not be larger than the parent or root security key from which the child key is derived.

In a conventional method, the UDM initiates a reauthentication of a UE based on an internal network function request to initiate reauthentication to refresh the UE specific home key (K_{AUSF}). A new primary reauthentication may require certain events at the network, resulting in a refresh of the latest home key K_{AUSF}. In such scenarios, an internal network function requests the UDM to trigger the reauthentication procedure. Upon receiving the reauthentication request from the internal network function, the UDM checks whether the primary reauthentication for the UE is to be initiated, or whether the request is to be rejected, based on the operator policy. The operator policy includes the details of the wait period for the new request, after the last successful authentication. If the operator policy allows, then the UDM requests the AMF currently serving the UE to initiate the primary authentication for the UE. Upon receiving the request from the UDM, the AMF or SEAF initiates the primary authentication (e.g., described in TS 33.501), resulting in the generation of fresh key material in the UE and in the network, if the primary authentication is performed successfully.

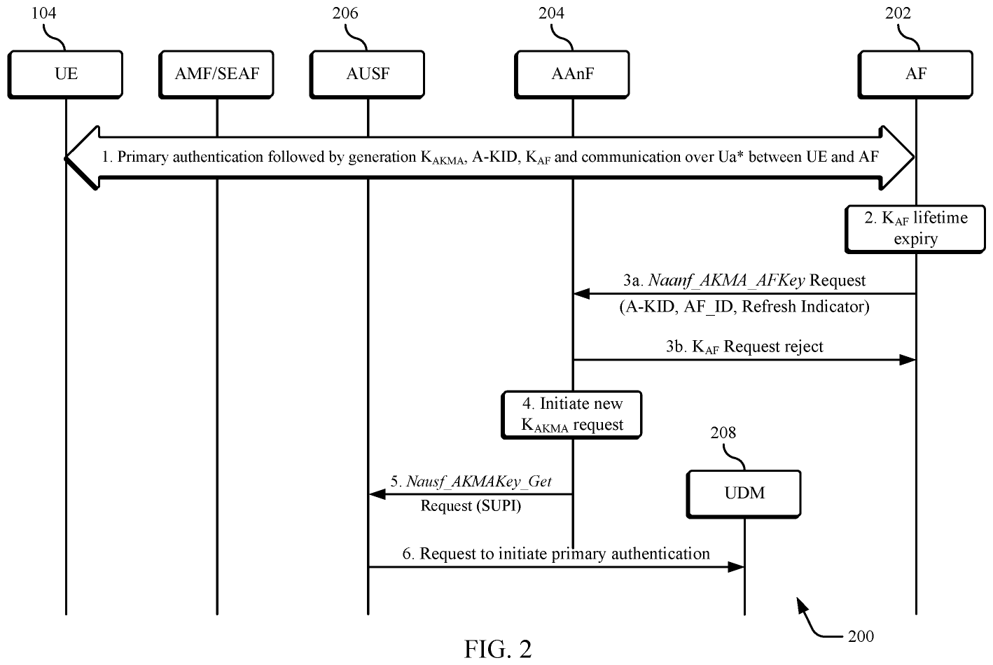

FIG. 2 illustrates an example 200 of authentication and key management for applications anchor key (K_{AKMA}) refresh conventional signaling as related to network initiated primary authentication. In an event the application function key (K_{AF}) expires, the application function (AF) 202 may request initiation of a fresh primary authentication using the signaling procedure. In this example 200, (at step 1) the UE 104 registers to the network with successful primary authentication and derives an AKMA key and an application function key for use based on the existing procedure. When the UE requests the application function (at steps 2, 3) for access, and if the K_{AF} lifetime expires or is about to expire, the application function requests the AKMA anchor function (AAnF) 204 to refresh the key K_{AF} by communicating a Naanf_AKMA_ApplicationKey_Get request, including a key refresh indicator. If the K_{AF} lifetime expires, the application function rejects the UE's access request because the old AKMA key identifier (A-KID) is no longer valid, and it requests the UE to connect using a new A-KID. Upon determining that the K_{AF} cannot be used further, since an A-KID associated K_{AF} is already used for the AF, the AAnF requests the AUSF 206 (at steps 4, 5) to generate a fresh K_{AKMA}, by sending a Nausf_AKMAKey_Get request along with the SUPI. Upon receiving the request from the AAnF, the AUSF requests the UDM 208 (at step 6) to trigger the re-authentication procedure.

Notably, there are limitations with these conventional techniques. For example, the UDM triggers the reauthentication, but in certain scenarios such as for SoR and UPU, it is the AUSF which is aware of the counter wrap initially. The AUSF is the authentication server function handling primary authentication, and the UDM triggering a reauthentication can lead to scenarios where a primary authentication or reauthentication is triggered without sufficient information. Further, the expiry time of the application key K_{AF} is set by the AKMA anchor function (AAnF) without considering any factors, and the expiration of K_{AF} leads to a service rejection for the UE until a new primary authentication is performed successfully to refresh K_{AKMA}. This solution is not optimal, given the potential for service failure of the UE's access request.

Aspects of the present disclosure include solutions to enable the home network to trigger primary authentication or reauthentication, taking into consideration factors such as the lifetime and/or expiry time related to the primary authentication (such as authentication vector or AUSF key), SoR counter wrap, and UPU counter wrap. Further the described solutions enable binding the lifetime or expiration time of the AKMA key (K_{AKMA}) and the application function key (K_{AF}) with the lifetime or expiration time of the primary authentication and the associated AUSF key (K_{AUSF}). This prevents service failure related to application function key expiry, and implicitly enforces the UE and AKMA anchor function (AAnF) to use the new AKMA key related to successful primary authentication or reauthentication following an application function key expiry. Aspects of the disclosure are directed to enabling home network triggered primary authentication and/or reauthentication, and the handling of related security keys for lifetime and/or expiry time. Aspects of the disclosure are also directed to setting the application function key expiry taking into consideration the AKMA key (K_{AKMA}) expiry and/or lifetime. Aspects of the disclosure are also directed to providing the AUSF and/or the AMF with authentication related lifetime and/or expiration time by the UDM.

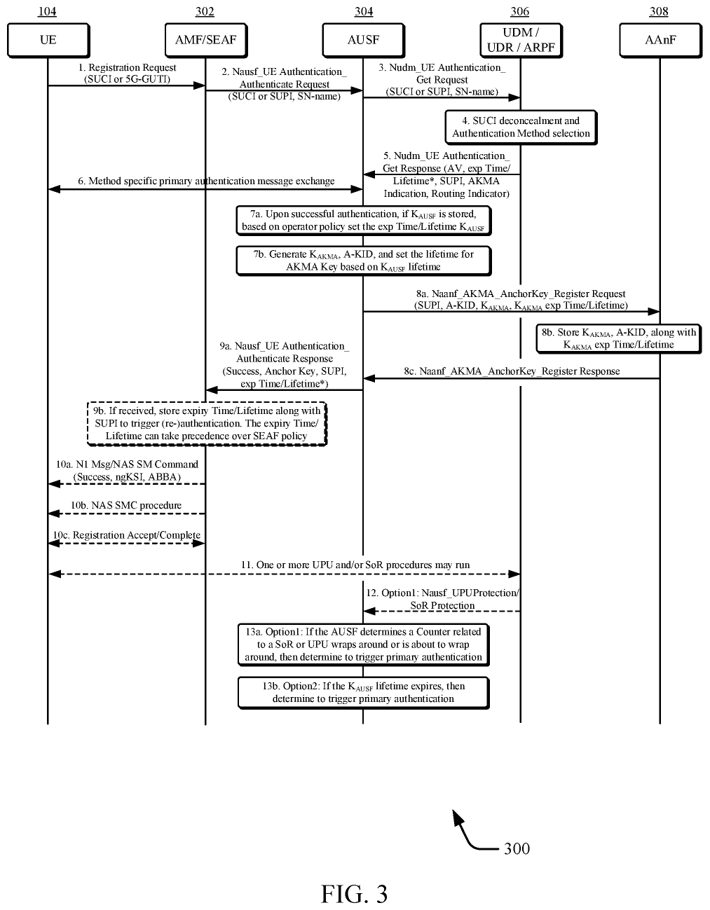

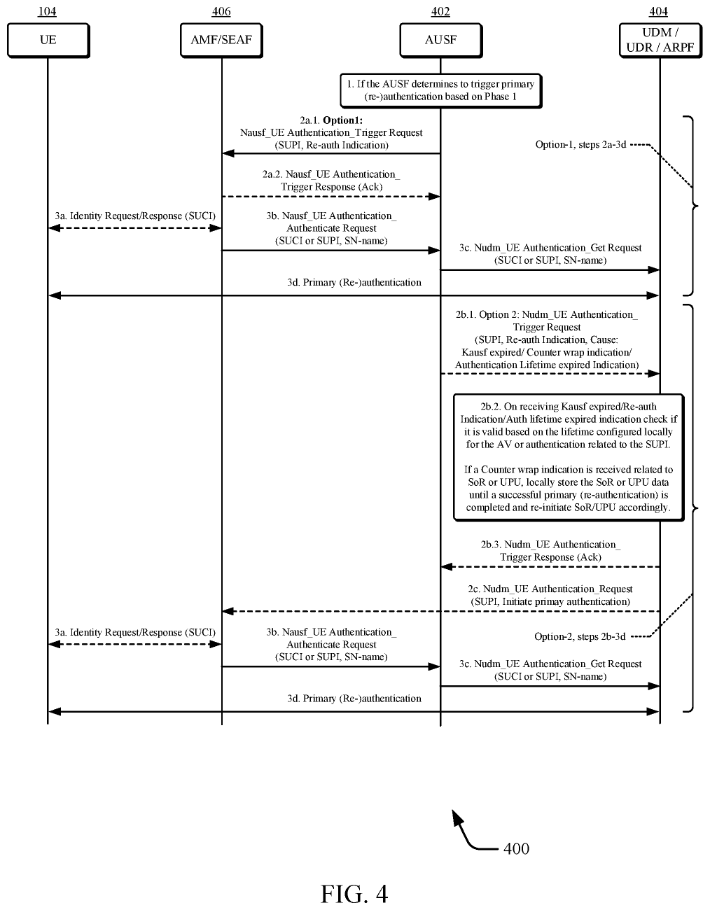

In implementations, various factors are considered by the AUSF to determine if a primary reauthentication is required, illustrated as phase-1 in FIG. 3, and the primary reauthentication can be triggered by the AUSF, illustrated as phase-2 in FIG. 4. Security aspects related to SoR, the UPU, and AKMA depend on AUSF Key, and the home network internal network function (NF) (i.e., AUSF and/or UDM) triggering a primary authentication should bind the lifetime or expiry time of primary authentication or reauthentication and AUSF Key with the SoR, UPU, and AKMA Key related security usage expiry time/lifetime. An implementation to enable a home network to trigger primary reauthentication includes two phases, including phase-1 signaling for factors considered by the AUSF to trigger primary reauthentication, and phase-2 signaling as a procedure for AUSF triggered reauthentication from a home network, where the AUSF can trigger the reauthentication either directly or indirectly via the UDM.

FIG. 3 illustrates an example 300 of phase-1 signaling for factors considered by the AUSF to trigger primary reauthentication, which supports network initiated primary authentication in accordance with aspects of the present disclosure. In this example 300, the UE 104 sends a registration request (at step 1) or in any N1 message (i.e., NAS message) with subscription concealed identifier (SUCI) or 5G globally unique temporary UE identity (GUTI). The AMF/SEAF 302 may initiate an authentication (at step 2) with the UE during any procedure establishing a signaling connection with the UE, according to the SEAF's policy. The SEAF can invoke the Nausf_UEAuthentication service by sending a Nausf_UEAuthentication_Authenticate request message to the AUSF 304 whenever the SEAF determines to initiate an authentication. The Nausf_UEAuthentication_Authenticate request can include SUCI or SUPI (i.e., SUPI is used if available or in case the AMF/SEAF receives 5G-GUTI, and the AMF has a SUPI locally stored along with the UE context related to the 5G-GUTI, where the SEAF may determine to reauthenticate the UE) and the serving network name.

The AUSF 304 communicates (e.g., sends, transmits at step 3) to the UDM 306, the Nudm_UEAuthentication_Get request, which can contain SUCI or SUPI and the serving network name. The UDM performs SUCI to SUPI de-concealment (at step 4) using the subscription identifier de-concealing function (SIDF) if a SUCI is received. Based on SUPI, the UDM/authentication credential repository and processing function (ARPF) shall choose the authentication method (extensible authentication protocol (EAP)-authentication and key agreement (AKA) or 5G AKA or any method). Based on the selected authentication method, the authentication vector (AV) is generated (at step 5) (i.e., EAP-AKA′ AV or 5G HE AV or any AV). The UDM, unified data repository (UDR), or ARPF may contain (based on operator configuration or home network operator policy) or set an expiry time/lifetime related to the primary authentication, AV, or AUSF Key to be used by the AUSF. The UDM sends to the AUSF, a Nudm_UEAuthentication_Get response message which can include AV, SUPI, an expiry time/lifetime indication (if available in UDM, UDR, or ARPF (or) if set by the UDM), an AKMA indication and routing indicator (i.e., if a subscriber has an AKMA subscription, UDM includes an AKMA indication and routing indicator). The expiry time/lifetime indication provided by the UDM can indicate one or more of the following to the AUSF: (i) the usage expiry time/lifetime of the AV, primary authentication, or AUSF key that is derived from the AV; (ii) to trigger a primary authentication or reauthentication considering the expiry time/lifetime provided by the UDM; or to bind or consider the expiry time/lifetime provided by the UDM to set the expiry time/lifetime of any security information derived from the AUSF Key associated to the AV or the primary authentication.

The AUSF performs (at step 6) an authentication method specific message exchange (i.e., one or more message exchanges related to the authentication) with the UE to perform mutual authentication related to the primary authentication. On successful mutual authentication (i.e., if the AUSF considers the primary authentication successful), the AUSF derives the AUSF Key (i.e., K_{AUSF}) (at step 7a) and based on the home network operator policy, stores the K_{AUSF} along with the SUPI. The AUSF sets the expiry time/lifetime for the AUSF Key (i.e., K_{AUSF}) if any an expiry time/lifetime indication is received from the UDM, or based on the home network operator policy (i.e., if the UDM does not provide any expiry time/lifetime in step 5). If the AUSF receives AKMA indication from UDM, then (at step 7b) the AUSF derives AKMA Key (i.e., K_{AKMA}) and A-KID from the AUSF Key (i.e., K_{AUSF}). The AUSF sets the expiry time/lifetime for the AKMA Key (i.e., K_{AKMA}) based on the expiry time/lifetime of the AUSF Key (i.e., K_{AUSF}). Where the AUSF can set the expiry time/lifetime for the AKMA Key (i.e., K_{AKMA}) same- as or lesser-than the expiry time/lifetime of the AUSF Key (i.e., K_{AUSF}) based on the home network operator policy or based on the expiry time/lifetime received from the UDM (in step 5).

The AUSF selects the AKMA Anchor Function (AAnF) 308 and sends (at step 8a) the generated A-KID, K_{AKMA} and AKMA Key expiry time/lifetime (i.e., K_{AKMA} expiry time/lifetime) to the AAnF together with the SUPI of the UE using the Naanf_AKMA_KeyRegistration request service operation. The AAnF can store the latest information, such as the latest A-KID, K_{AKMA} and AKMA Key expiry time/lifetime (i.e., K_{AKMA} expiry time/lifetime) sent by the AUSF. Note that when reauthentication runs, the AUSF generates a new A-KID and a new K_{AKMA}, and sets the new AKMA Key expiry time/lifetime and sends the new generated A-KID, the new K_{AKMA}, and the new AKMA Key expiry time/lifetime to the AAnF. After receiving the new generated A-KID, K_{AKMA} and new AKMA Key expiry time/lifetime, the AAnF deletes the old A-KID, K_{AKMA}, and AKMA Key expiry time/lifetime, and stores the new generated A-KID, K_{AKMA}, and new AKMA Key expiry time/lifetime.

The AAnF stores (at step 8b) the received SUPI, A-KID, K_{AKMA}, and AKMA Key expiry time/lifetime (i.e., K_{AKMA} exp time/lifetime). The AAnF sends (at step 8c) the response to the AUSF using the Naanf_AKMA_AnchorKey_Register response service operation. Note that steps 7b to 8c may occur immediately after step 7a or may occur anytime soon after step 9. Following a successful primary authentication, the AUSF (at step 9a) can derive K_{SEAF} from K_{AUSF} and sends to SEAF the Nausf_UEAuthentication_Authenticate response message, which can include success, Kseaf (i.e., Anchor Key), SUPI and expiry time/lifetime (based on the home network operator policy if implemented). The next step 9b is performed only if the AMF/SEAF receives expiry time/lifetime from the AUSF, where the AMF/SEAF locally stores the expiry time/lifetime along with the SUPI and uses the expiry time/lifetime to invoke primary authentication or reauthentication for the UE based on the trigger (i.e., expiry time/lifetime set) by the home network (i.e., AUSF/UDM) if received in step 9a. If the step 9b is performed, and if the AMF (i.e., source AMF), upon reception of the NGAP handover required message, the source AMF can provide the expiry time/lifetime (i.e., as related to the primary authentication) to the Target AMF in the Namf_Communication_CreateUEContext request message, where the target AMF/SEAF can store the expiry time/lifetime along with the SUPI and UE context, and the locally stored expiry time/lifetime can be used to invoke primary authentication or reauthentication for the UE.

The AMF/SEAF sends (at step 10a) the success message (i.e., an EAP success message in the case of EAP-AKA′), key set identifier in 5G (ngKSI), anti-bidding down between architectures (ABBA) parameter to the UE in the N1 message, which can be a NAS Security mode command or authentication result. The UE sends (at step 10b) to AMF/SEAF the NAS security mode complete message. The AMF can send (at step 10c) a registration accept message to the UE and may receive a registration complete message from the UE. The home network (i.e., UDM) (at step 11) may initiate and run one or more SoR and/or UPU procedures with the UE, where the UPU and SoR procedure is secured based on the AUSF Key using the protection service offered by the AUSF. At a later point in time (at step 12), the UDM may request AUSF related to Nausf protection service of SOR or UPU for the UE. If the AUSF determines (at step 13a) that the counter related to the SoR or UPU wraps around or is about to wrap around, then the AUSF can determine to trigger a primary authentication or reauthentication. Alternatively, if the AUSF finds (at step 13b) that the locally available AUSF expiry time/lifetime is expired or is about to expire, then the AUSF can determine to trigger a primary authentication or reauthentication.

Additionally, the following factors can be considered by the AUSF to trigger primary reauthentication, where the factors can include one or more of the following: K_{AUSF} lifetime expiry; authentication vector lifetime expiry; primary authentication lifetime expiry; counter wrap around related to a steering of roaming procedure, or UE parameter update procedure, or any security procedure dependent on K_{AUSF} as the root key; or home network operator configured or UDM provided expiry time/lifetime related to a primary authentication or an associated security context (such as AV or AUSF key).

Once the AUSF determines to trigger a primary authentication or reauthentication as described above with reference to phase-1 shown in FIG. 3, then the phase-2 as shown and described below with reference to FIG. 4 can be implemented. Note that the network function (NF) (i.e., AUSF or UDM) can store the expiration time/lifetime of a primary authentication along with serving network name, serving NF information (i.e., AMF ID), SUPI per access type (i.e., 3GPP access and non-3GPP access). The reauthentication related to a different serving network for the UE can be triggered independently per access type specific to the serving network via the respective AMF/SEAF(s).

FIG. 4 illustrates an example 400 of phase-2 signaling as a procedure for AUSF triggered reauthentication from a home network, which supports network initiated primary authentication in accordance with aspects of the present disclosure. In this example 400, the AUSF 402 can trigger authentication or reauthentication from a home network, where the AUSF can trigger the reauthentication either directly or indirectly via the UDM 404. The AUSF determines (at step 1) to trigger primary authentication or reauthentication as described in Phase-1. Then based on the implementation, the AUSF either performs Option-1 (i.e., steps 2a, 3a, 3b, 3c, and 3d to trigger and perform primary reauthentication, or performs Option-2 (i.e., steps 2b, 2c, 2d, 3a, 3b, 3c, and 3d to trigger and perform primary reauthentication.

In implementation of Option-1, the AUSF directly triggers the primary authentication or reauthentication with the AMF/SEAF 406 serving the UE 104. The AUSF (at step 2a.1) sends a new service operation message to AMF/SEAF, which can include SUPI and an indication, which indicates that a primary authentication or reauthentication is required, or a primary authentication or reauthentication is initiated by the home network. The new service operation message to support triggering primary authentication or reauthentication can be termed as any of the following: Nausf_UE Authentication_Trigger request; existing Nausf_UE Authentication request can be reused for this purpose; Nausf_UE Re-Authentication request; Nausf_UE Re-Authentication notification; Nausf_UE Authentication_Trigger notification; or Nausf_UE Authentication_Initiate request/notification.

The AMF/SEAF (at step 2a.2) on receiving at step 2a.1, can send an ACK indication in the response message, which can be termed as any of the following: Nausf_UE Authentication_Trigger response; Existing Nausf_UE authentication response can be reused for this purpose; Nausf_UE reauthentication response; Nausf_UE reauthentication notification response or ACK; Nausf_UE Authentication_Trigger notification response or ACK; or Nausf_UE Authentication_Initiate response or notification ACK.

The AMF/SEAF may initiate (at step 3a) an identity request/response with the UE, where the AMF/SEAF can send an identity request to the UE and can receive from UE, an identity response with SUCI. The SEAF may initiate (at step 3b) a primary authentication or reauthentication with the UE based on the indication received from the AUSF (in step 2a.1). The SEAF can send to AUSF, the Nausf_UEAuthentication_Authenticate request message which can include SUCI or SUPI (i.e., SUPI is used if available or SUCI that is received in step 3a is used), and the serving network name. The AUSF sends (at step 3c) to UDM, the Nudm_UEAuthentication_Get request which can contain SUCI or SUPI and the serving network name. The UDM (at step 3d) performs SUCI to SUPI de-concealment using the SIDF if a SUCI is received. Based on SUPI, the UDM/ARPF shall choose the authentication method, and then perform an authentication specific message exchange with the AUSF. The AUSF and UE can exchange authentication method specific message exchange with the UE to perform mutual authentication. The Phase-1 steps 5 to 10b such as shown and described with reference to FIG. 3 are applicable here. The UE and the network successfully reauthenticates and establishes NAS Security and AS security based on the new security context (K_{AUSF} and K_{SEAF}) derived from the successful primary authentication or reauthentication.

In implementation of Option-2, the AUSF in-directly triggers primary authentication or reauthentication with the AMF/SEAF serving the UE via the UDM. The AUSF (at step 2b) sends to the UDM a request message which can include SUPI, a re-auth indication, any cause value such as a K_{AUSF} expiry indication, a SoR counter wrap around indication, a UPU counter wrap around indication, an authentication lifetime expiry indication, and/or AV lifetime expiry indication. The request message used in step 2b can include any new service operation message to support triggering primary authentication or reauthentication, and it can be termed as any of the following: Nudm_UE Authentication_Trigger request; Existing Nudm_UE Authentication get request can be reused for this purpose; Nudm_UE Re-Authentication request; Nudm_UE Re-Authentication notification; Nudm_UE Authentication_Trigger notification; or Nudm_UE Authentication_Initiate request/notification.

The UDM (at step 2b.2) on receiving any of: a re-auth indication, a K_{AUSF} expiry indication, a SoR counter wrap around indication, a UPU counter wrap around indication, authentication lifetime expiry indication and/or AV lifetime expiry indication, checks if it is valid based on the expiry time/lifetime locally configured for the AV or primary authentication or reauthentication related to the SUPI according to the home network operator policy. If a counter wrap around indication is received related to SoR or UPU which is ongoing or required to be sent, the UDM/UDR can locally store the SoR or UPU data until a successful primary reauthentication is completed and re-initiate SoR/UPU accordingly. The UDM (at step 2b.3) on receiving the step 2b.1 can send an ACK indication in the response message, where in the response message can be termed as any of the following: Nudm_UE Authentication_Trigger response; Existing Nudm_UE Authentication get response can be reused for this purpose; Nudm_UE Re-Authentication response; Nudm_UE Re-Authentication notification response or ACK; Nudm_UE Authentication_Trigger notification response or ACK; or Nudm_UE Authentication_Initiate response or notification ACK.

As an alternative option A, the UDM on receiving (at step 2b.1), can select the authentication method based on SUPI, and generate the AV specific to the selection authentication method. Construction of the serving network name by the UDM, UDR, or ARPF: the UDM, UDR, or ARPF can check the serving AMF/SEAF of the UE based on SUPI and construct the serving network name for the specific AMF/SEAF. For example, it can set the service code to “5G”, it can set the network identifier to the serving network identifier (SN Id) of the serving network to which the authentication data is sent by the AUSF; and it can concatenate the service code and the SN Id with the separation character “:”. The UDM can send to the AUSF, the Nudm_UE Authentication get response with AV, expiry time/lifetime*, SUPI, AKMA indication, routing indicator, re-auth acknowledgement, serving AMF/SEAF identifier (or information), and the computed SNN. If this alternative option is implemented, then the steps 2d-3c may be skipped and step 3d can be performed, which includes performing primary authentication based on the AV if sent by the UDM (in step 2.b.2). In this case, the step 3d includes operations related to step 6, 7a, 7b, 8a, 8b, 8c, 9, 10a, 10a, and/or 10b of the Phase-1 procedure such as shown and described with reference to FIG. 3 above.

As another alternative option B, the UDM can send to the serving AMF, the SUPI and initiate primary authentication or reauthentication indication in a Nudm_UE Authentication_Request or Nudm_UE authentication or reauthentication trigger message. The AMF/SEAF may initiate (at step 3a) an identity request/response with the UE, where the AMF/SEAF can send an identity request to the UE and can receive from UE, an identity response with SUCI. The SEAF may initiate (at step 3b) a primary authentication or reauthentication with the UE based on the indication received from the UDM (in step 2c.1). The SEAF can send to AUSF, the Nausf_UEAuthentication_Authenticate request message, which can include SUCI or SUPI (i.e., SUPI is used if available or SUCI that is received in step 3a is used) and the serving network name. The AUSF sends (at step 3c) to the UDM, the Nudm_UEAuthentication_Get request which can contain SUCI or SUPI and the serving network name. The UDM (at step 3d) performs SUCI to SUPI de-concealment using the SIDF if a SUCI is received. Based on SUPI, the UDM/ARPF shall choose the authentication method, and then performs an authentication specific message exchange with the AUSF. The AUSF and UE can exchange authentication method specific message exchange with the UE to perform mutual authentication. The steps 5 to 10b described such as shown and described with reference to FIG. 3 are applicable here.

The UE and the network successfully reauthenticates and establishes NAS security and AS security based on the new security context (K_{AUSF} and K_{SEAF}) derived from the successful primary authentication or reauthentication.

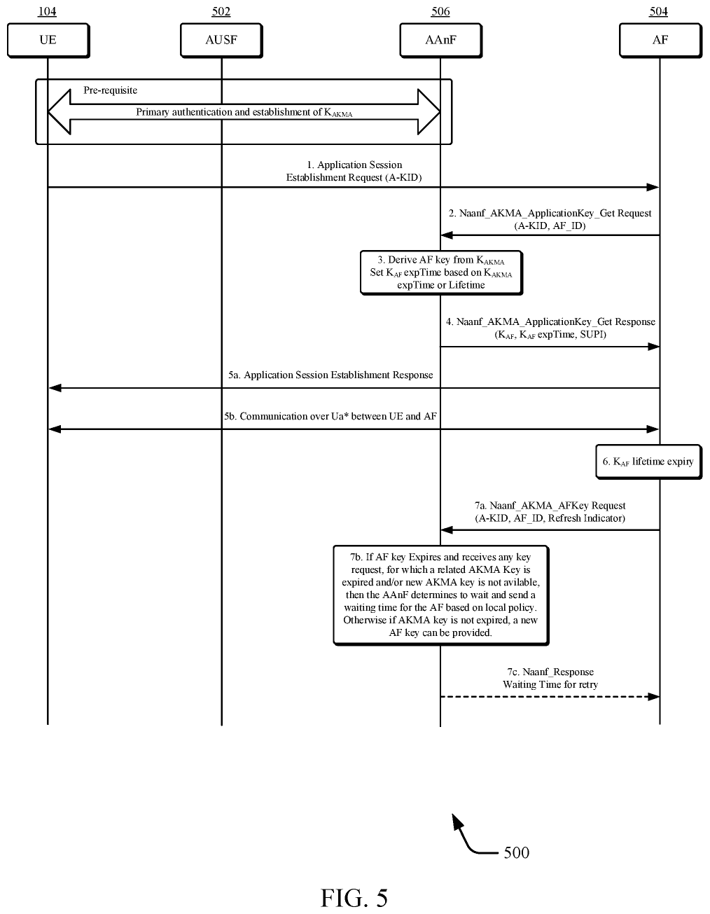

FIG. 5 illustrates an example 500 of setting the expiry time and/or lifetime for an application function key that supports network initiated primary authentication in accordance with aspects of the present disclosure. In this example 500, the expiry time and/or the lifetime can be set for the AF key based on the lifetime and/or expiry time provided by the home network NF, such as the AUSF 502 (or in turn via AUSF from UDM). The expiry time and/or lifetime can be set for the AF key based on the validity of the primary authentication, AUSF key, or AKMA Key as the AF key is derived from the AKMA key, which in turn is derived from the AUSF key following a successful authentication. The implementation also prevents service rejection by an AAnF due to AF key expiry, where the implementation updates the AAnF soon after every successful primary authentication or reauthentication with the new AKMA Key along with the expiry-time and/or lifetime to be considered for any security usage, such as AF key generation or refresh and usage of the AF keys (i.e., AF key expiry time).

In this example 500, the UE 104 can generate (at step 1) the AKMA anchor key (K_{AKMA}) and the A-KID from the K_{AUSF} before initiating communication with an AKMA application function. When the UE initiates communication with the AKMA AF 504, it can include the derived A-KID in the application session establishment request message. The UE may derive K_{AF} before sending the message or afterwards. If the AF does not have an active context associated with the A-KID, then (at step 2) the AF selects the AAnF 506, and sends a Naanf_AKMA_ApplicationKey_Get request to AAnF with the A-KID to request the K_{AF} for the UE. The AF also includes its identity (AF_ID) in the request. The AAnF verifies whether the subscriber is authorized to use AKMA based on the presence of the UE specific K_{AKMA} key identified by the A-KID. If K_{AKMA} is present in AAnF, the AAnF continues with step 3. If K_{AKMA} is not present in the AAnF, the AAnF continues with step 4 with an error response.

The AAnF derives (at step 3) the AKMA application key (K_{AF}) from K_{AKMA} if it does not already have K_{AF}. Then the AAnF sets the expiration time for the K_{AF} considering the locally stored expiration time and/or lifetime of the AKMA Key, where the expiration time for the K_{AF} can be lesser than or equal to the expiration time and/or lifetime of the AKMA Key. The expiration time and/or lifetime of the AKMA Key available at the AAnF can be used to define the maximum usage lifetime of the K_{AF}, where the AAnF can determine not to use or refresh K_{AF} beyond the expiration time and/or lifetime of the associated AKMA Key (i.e., the AAnF can determine to use or refresh K_{AF} related to A-KID only up to the expiration time and/or lifetime of the associated AKMA Key).

The AAnF sends (at step 4) a Naanf_AKMA_ApplicationKey_Get response to the AF with SUPI, K_{AF}, and the K_{AF} expiration time. The AF sends (at step 5a) the application session establishment response to the UE. If the information in step 4 indicates failure of the AKMA key request, the AF can reject the application session establishment by including a failure cause. Afterwards, the UE may trigger a new application session establishment request with the latest A-KID to the AKMA AF. Following a successful AF key establishment, the UE can communicate (at step 5b) with the AF and use the application. At a later point in time, following steps may be performed. When the UE requests the AF for access, and if the K_{AF} lifetime expires or is about to expire (determined at step 6), the AF (at step 7a) requests the AAnF to refresh the key K_{AF} by sending Naanf_AKMA_ApplicationKey_Get request, including a key refresh indicator.

The AAnF (at step 7b) may find that the K_{AF} lifetime expires, and the AAnF performs the following: The AAnF checks the locally available AKMA Key expiration time and/or lifetime for the associated A-KID, and if the expiration time and/or lifetime is not expired, then the AAnF can determine to refresh the AF Key; or the AAnF checks the locally available AKMA Key expiration time and/or lifetime for the associated A-KID, and if the expiration time and/or lifetime is expired, then the AAnF can determine not to refresh the AF Key and determines to wait for the new AKMA key to be provided by the home network (i.e., AUSF). The AAnF sends (at step 7c) to the AF, a Naanf_Response message, which can include a waiting time (r), if the AAnF finds that the AKMA Key that is available is expired and it is yet to receive the new AKMA key related to the new A-KID provided by the AF, or if the AAnF receives an A-KID for which the existing AKMA Key is already expired. The waiting time (r) can be used by the AF to retry the key request procedure with AAnF. The AAnF sends to the AF, the Naanf Response message, which can include a new AF Key if the AAnF finds that the AKMA Key that is available and related to the new A-KID is not-expired. Note that the external AF can request an AF Key from the AAnF via a NEF, and in such a case, the steps 2, 4, 7a, and 7c will be exchanged via a NEF, where the NEF will receive and forward message exchange between AF and AAnF respectively.

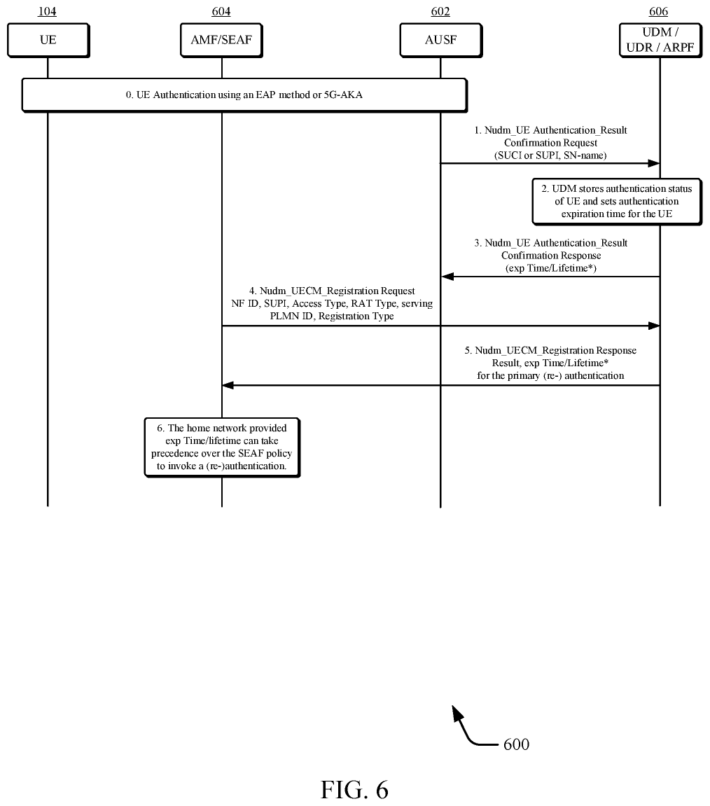

FIG. 6 illustrates an example 600 of providing authentication related lifetime and/or expiration time after a successful primary authentication that supports network initiated primary authentication in accordance with aspects of the present disclosure. This is an alternative method to provide the AUSF 602 and/or the AMF 604 with authentication related lifetime and/or expiration time by the UDM. In this example 600, the AUSF (at step 1) informs the UDM 606 about the result and time of an authentication procedure with a UE using a Nudm_UEAuthentication_ResultConfirmation request. This can include the SUPI, a timestamp of the authentication, the authentication type (e.g. EAP method or 5G-AKA), and the serving network name. The UDM can store (at step 2) the authentication status of the UE (SUPI, authentication result, timestamp, and the serving network name) and the UDM can set the expiration time (exp time) and/or lifetime of the primary authentication for the UE based on the operator local policy.

The UDM can reply (at step 3) to the AUSF with a Nudm_UEAuthentication_ResultConfirmation response which can include the expiration time and/or lifetime (related to primary authentication), and can store it along with the SUPI. The AUSF on receiving the expiration time and/or lifetime can perform triggering primary authentication or reauthentication when the expiration time is about to be reached or the lifetime is about to be expired based on the implementation-1, phase-2 description (i.e., option-1 (AUSF directly triggering primary authentication or reauthentication with the AMF/SEAF serving the UE), or by requesting AV for the SUPI and serving network, and initiating an authentication request with the AMF for the primary authentication.

Upon reception of subsequent UE related procedures, the UDM (at step 4) receives a Nudm_UECM_Registration_Request from the AMF, and the UDM may apply actions according to the home operator's policy to detect and achieve protection against certain types of fraud. The Nudm_UECM_Registration_Request can include NF ID, SUPI, access type, RAT type, serving PLMN ID, and/or registration type (if the access type is 3GPP access). Then the UDM can send (at step 5) to the AMF, a Nudm_UECM_Registration_Response which can include SUPI and expiration time and/or lifetime (related to primary authentication). The AMF/SEAF can locally store (at step 6) the expiration time and/or lifetime (related to primary authentication) along with the SUPI and UE context. On an expiration of primary authentication considering the received and locally stored expiration time and/or lifetime, the AMF/SEAF can invoke a primary authentication or reauthentication for the UE (i.e., SUPI). The home network provided expiration time and/or lifetime can take precedence over the SEAF policy to invoke a authentication or reauthentication. Note that the UDM may either provide the expiration time and/or lifetime to the AUSF (i.e., in step 3) or to the AMF (i.e., in step 5).

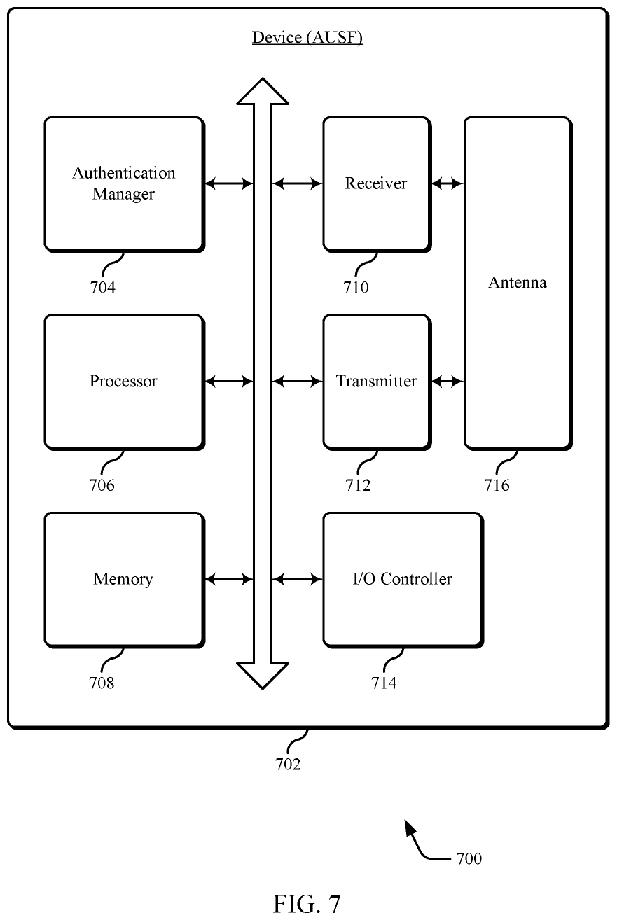

FIG. 7 illustrates an example of a block diagram 700 of a device 702 that supports network initiated primary authentication in accordance with aspects of the present disclosure. The device 702 may be an example of a device that implements an AUSF as described herein. The device 702 may support wireless communication and/or network signaling with one or more base stations 102, UEs 104, network entities and devices, or any combination thereof. The device 702 may include components for bi-directional communications including components for transmitting and receiving communications, such as an authentication manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The authentication manager 704, the receiver 710, the transmitter 712, or various combinations thereof or various components thereof may be examples of means for performing various aspects of the present disclosure as described herein. For example, the authentication manager 704, the receiver 710, the transmitter 712, or various combinations or components thereof may support a method for performing one or more of the functions described herein.

In some implementations, the authentication manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the authentication manager 704, the receiver 710, the transmitter 712, or various combinations or components thereof may be implemented in code (e.g., as communications management software or firmware) executed by the processor 706. If implemented in code executed by the processor 706, the functions of the authentication manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the authentication manager 704 may be configured to perform various operations (e.g., receiving, monitoring, transmitting) using or otherwise in cooperation with the receiver 710, the transmitter 712, or both. For example, the authentication manager 704 may receive information from the receiver 710, send information to the transmitter 712, or be integrated in combination with the receiver 710, the transmitter 712, or both to receive information, transmit information, or perform various other operations as described herein. Although the authentication manager 704 is illustrated as a separate component, in some implementations, one or more functions described with reference to the authentication manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the authentication manager 704 may support wireless communication and/or network signaling at a device (e.g., the device 702, an AUSF) in accordance with examples as disclosed herein. The authentication manager 704 and/or other device components may be configured as or otherwise support an apparatus, including a transceiver; a processor coupled to the transceiver, the processor and the transceiver configured to cause the apparatus to: receive an authentication request from a security anchor function (SEAF); transmit a data request for authentication data to unified data management (UDM); receive the authentication data from the UDM for primary authentication; set an expiration time for security information associated with the primary authentication being successful; transmit an authentication message of authentication information comprising at least the security information and the expiration time to an authentication and key management for applications (AKMA) anchor function (AAnF) that registers the expiration time; and initiate reauthentication based at least in part on expiry of the authentication information.

Additionally, the apparatus (e.g., a device, AUSF) includes any one or combination of: the authentication information comprises at least one of a steering of roaming (SoR) counter wrap around or a user equipment (UE) parameter update (UPU) counter wrap around, and the processor is configured to cause the apparatus to initiate the reauthentication based on the expiry of the SoR counter wrap around or the UPU counter wrap around. The authentication information comprises an authentication server function (AUSF) key (K_{AUSF}) lifetime, and the processor is configured to cause the apparatus to initiate the reauthentication based on the expiry of the K_{AUSF} lifetime. The processor is configured to cause the apparatus to initiate the reauthentication based on a reauthentication policy by a home network operator. The security information comprises one or more of an AUSF key (K_{AUSF}), an AKMA key (K_{AKMA}), an authentication vector, a primary authentication status, or a primary authentication result. The processor and the transceiver are configured to cause the apparatus to transmit the authentication message to the AAnF as an AKMA key (K_{AKMA}) register request comprising one or more of a UE subscription permanent identifier (SUPI), an AKMA key identifier (A-KID), a K_{AKMA}, or an expiry time of the K_{AKMA}. The processor and the transceiver are configured to cause the apparatus to transmit an authentication response to the SEAF, the authentication response comprising one or more of an indication of authentication success, a SUPI, an AKMA key (K_{AKMA}), or an expiry time of the primary authentication. The authentication data received from UDM comprises one or more of an authentication vector (AV), an expiry time of the AV, an expiry time of the primary authentication, a SUPI, an AKMA indication, or a routing indicator. The processor and the transceiver are configured to cause the apparatus to transmit an authentication trigger request to the AMF/SEAF to initiate reauthentication, the authentication trigger request comprising one or more of a SUPI or an indication that reauthentication is required. The processor and the transceiver are configured to cause the apparatus to receive an acknowledgement (ACK) from the AMF/SEAF in response to an authentication trigger request transmitted to the AMF/SEAF. The processor and the transceiver are configured to cause the apparatus to transmit an authentication trigger request to the UDM, the authentication trigger request comprising one or more of a SUPI, an indication that reauthentication is required, or an indication as to a cause of the authentication trigger request. The cause of the authentication trigger request comprises one or more of an expired AUSF key (K_{AUSF}), a counter wrap expiry indication, or an authentication lifetime expired indication. The processor and the transceiver are configured to cause the apparatus to receive an ACK from the UDM in response to an authentication trigger request transmitted to the UDM. The processor and the transceiver are configured to cause the apparatus to receive authentication result information from the UDM, the authentication result information comprising an expiration time and an authentication result confirmation.

The authentication manager 704 and/or other device components may be configured as or otherwise support a means for wireless communication and/or network signaling at a device (e.g., AUSF), including receiving an authentication request from a security anchor function (SEAF); transmitting a data request for authentication data to unified data management (UDM); receiving the authentication data from the UDM for primary authentication; setting an expiration time for security information associated with the primary authentication being successful; transmitting an authentication message of authentication information comprising at least the security information and the expiration time to an authentication and key management for applications (AKMA) anchor function (AAnF) that registers the expiration time; and initiating reauthentication based at least in part on expiry of the authentication information.

Additionally, wireless communication and/or network signaling at the device includes any one or combination of: the authentication information comprises at least one of a steering of roaming (SoR) counter wrap around or a user equipment (UE) parameter update (UPU) counter wrap around, and the reauthentication initiated based on the expiry of the SoR counter wrap around or the UPU counter wrap around. The authentication information comprises an authentication server function (AUSF) key (K_{AUSF}) lifetime, and the reauthentication initiated based on the expiry of the K_{AUSF} lifetime. The reauthentication is initiated based on a reauthentication policy by a home network operator. The security information comprises one or more of an AUSF key (K_{AUSF}), an AKMA key (K_{AKMA}), an authentication vector, a primary authentication status, or a primary authentication result. The method further comprising transmitting the authentication message to the AAnF as an AKMA key (K_{AKMA}) register request comprising one or more of a UE subscription permanent identifier (SUPI), an AKMA key identifier (A-KID), a K_{AKMA}, or an expiry time of the K_{AKMA}. The method further comprising transmitting an authentication response to the SEAF, the authentication response comprising one or more of an indication of authentication success, a SUPI, an AKMA key (K_{AKMA}), or an expiry time of the primary authentication. The authentication data received from the UDM comprises one or more of an authentication vector (AV), an expiry time of the AV, an expiry time of the primary authentication, a SUPI, an AKMA indication, or a routing indicator. The method further comprising transmitting an authentication trigger request to the AMF/SEAF to initiate reauthentication, the authentication trigger request comprising one or more of a SUPI or an indication that reauthentication is required. The method further comprising receiving an acknowledgement (ACK) from the AMF/SEAF in response to an authentication trigger request transmitted to the AMF/SEAF. The method further comprising transmitting an authentication trigger request to the UDM, the authentication trigger request comprising one or more of a SUPI, an indication that reauthentication is required, or an indication as to a cause of the authentication trigger request. The cause of the authentication trigger request comprises one or more of an expired AUSF key (K_{AUSF}), a counter wrap expiry indication, or an authentication lifetime expired indication. The method further comprising receiving an ACK from the UDM in response to an authentication trigger request transmitted to the UDM. The method further comprising receiving authentication result information from the UDM, the authentication result information comprising an expiration time and an authentication result confirmation.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

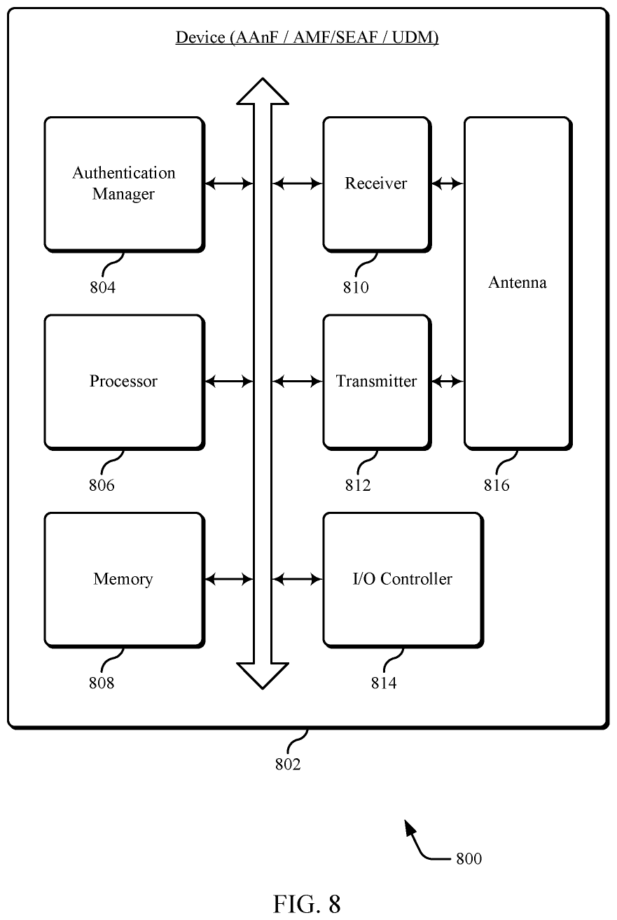

FIG. 8 illustrates an example of a block diagram 800 of a device 802 that supports network initiated primary authentication in accordance with aspects of the present disclosure. The device 802 may be an example of a device that implements any one or more of an AAnF, an AMF/SEAF, or a UDM as described herein. The device 802 may support wireless communication and/or network signaling with one or more base stations 102, other UEs 104, core network devices and functions (e.g., core network 106), or any combination thereof. The device 802 may include components for bi-directional communications including components for transmitting and receiving communications, such as an authentication manager 804, a processor 806, a memory 808, a receiver 810, a transmitter 812, and an I/O controller 814. These components may be in electronic communication or otherwise coupled (e.g., operatively, communicatively, functionally, electronically, electrically) via one or more interfaces (e.g., buses).

The authentication manager 804, the receiver 810, the transmitter 812, or various combinations thereof or various components thereof may be examples of means for performing various aspects of the present disclosure as described herein. For example, the authentication manager 804, the receiver 810, the transmitter 812, or various combinations or components thereof may support a method for performing one or more of the functions described herein.

In some implementations, the authentication manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the authentication manager 804, the receiver 810, the transmitter 812, or various combinations or components thereof may be implemented in code (e.g., as communications management software or firmware) executed by the processor 806. If implemented in code executed by the processor 806, the functions of the authentication manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the authentication manager 804 may be configured to perform various operations (e.g., receiving, monitoring, transmitting) using or otherwise in cooperation with the receiver 810, the transmitter 812, or both. For example, the authentication manager 804 may receive information from the receiver 810, send information to the transmitter 812, or be integrated in combination with the receiver 810, the transmitter 812, or both to receive information, transmit information, or perform various other operations as described herein. Although the authentication manager 804 is illustrated as a separate component, in some implementations, one or more functions described with reference to the authentication manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the authentication manager 804 may support wireless communication and/or network signaling at a device (e.g., the device 802, an AAnF) in accordance with examples as disclosed herein. The authentication manager 804 and/or other device components may be configured as or otherwise support an apparatus, including a transceiver; a processor coupled to the transceiver, the processor and the transceiver configured to cause the apparatus to: receive an authentication message from an authentication server function (AUSF), the authentication message comprising authentication information including at least security information and an expiration time; maintain the security information and the expiration time, the security information comprising at least an authentication and key management for applications (AKMA) key (K_{AKMA}); and transmit a register response to the AUSF as a confirmation of the AKMA key (K_{AKMA}) being registered.

Additionally, the apparatus (e.g., a device, an AAnF) includes any one or combination of: the authentication message is received from the AUSF as an AKMA key (K_{AKMA}) register request comprising one or more of a UE subscription permanent identifier (SUPI), an AKMA key identifier (A-KID), the K_{AKMA}, or an expiry time of the K_{AKMA}. The processor is configured to cause the apparatus to derive an application function (AF) key (K_{AF}) from the AKMA key (K_{AKMA}), and set a K_{AF} expiry time based on one of the expiration time or a lifetime of the K_{AKMA}. The processor and the transceiver are configured to cause the apparatus to receive a key request for the AKMA key (K_{AKMA}) from an application function (AF); and transmit a waiting time response to the AF based at least in part on a determination that the AKMA key (K_{AKMA}) has expired. The processor and the transceiver are configured to cause the apparatus to receive a key request for the AKMA key (K_{AKMA}) from an AF, the key request comprising an AKMA key identifier (A-KID); determine whether a stored AKMA key expiration time or lifetime has expired for the associated A-KID; and one of determine to refresh the AF key if the stored AKMA key expiration time or lifetime has not expired; or determine not to refresh the AF Key if the stored AKMA key expiration time or lifetime has expired, and wait for the new AKMA key to be provided by the AUSF.

The authentication manager 804 and/or other device components may be configured as or otherwise support a means for wireless communication and/or network signaling at a device (e.g., AAnF), including receiving an authentication message from an authentication server function (AUSF), the authentication message comprising authentication information including at least security information and an expiration time; maintaining the security information and the expiration time, the security information comprising at least an authentication and key management for applications (AKMA) key (K_{AKMA}); and transmitting a register response to the AUSF as a confirmation of the AKMA key (K_{AKMA}) being registered.

Additionally, wireless communication and/or network signaling at the device includes any one or combination of: the authentication message is received from the AUSF as an AKMA key (K_{AKMA}) register request comprising one or more of a UE subscription permanent identifier (SUPI), an AKMA key identifier (A-KID), the K_{AKMA}, or an expiry time of the K_{AKMA}. The method further comprising deriving an application function (AF) key (K_{AF}) from the AKMA key (K_{AKMA}), and set a K_{AF} expiry time based on one of the expiration time or a lifetime of the K_{AKMA}. The method further comprising receiving a key request for the AKMA key (K_{AKMA}) from an application function (AF); and transmitting a waiting time response to the AF based at least in part on a determination that the AKMA key (K_{AKMA}) has expired. The method further comprising: receiving a key request for the AKMA key (K_{AKMA}) from an AF, the key request comprising an AKMA key identifier (A-KID); determining whether a stored AKMA key expiration time or lifetime has expired for the associated A-KID; and one of: determining to refresh the AF key if the stored AKMA key expiration time or lifetime has not expired; or determining not to refresh the AF Key if the stored AKMA key expiration time or lifetime has expired, and wait for the new AKMA key to be provided by the AUSF.

Further, the authentication manager 804 and/or other device components may be configured as or otherwise support an apparatus, including a transceiver; a processor coupled to the transceiver, the processor and the transceiver configured to cause the apparatus to: receive a registration request from a user equipment (UE); transmit an authentication request to an authentication server function (AUSF); receive an authentication response from the AUSF, the authentication response comprising an indication of authentication success and at least one of an expiration time or a lifetime of authentication duration; and maintain the at least one expiration time or the lifetime of the authentication duration along with a UE subscription permanent identifier (SUPI) configured to trigger a reauthentication.

Additionally, the apparatus (e.g., a device, an AMF/SEAF) includes any one or combination of: the processor and the transceiver are configured to cause the apparatus to store the at least one expiration time or lifetime of authentication duration; and initiate to trigger the reauthentication of the UE based at least in part on the at least one expiration time or lifetime of the authentication duration. The processor and the transceiver are configured to cause the apparatus to transmit the at least one expiration time or lifetime of authentication duration to a target access and mobility management function (AMF) in response to receiving a handover required message, the target AMF configured to store the at least one expiration time or lifetime of authentication duration along with the SUPI and UE context, usable to invoke the reauthentication. The processor and the transceiver are configured to cause the apparatus to receive an authentication trigger request from the AUSF to initiate reauthentication, the authentication trigger request comprising one or more of a SUPI or an indication that reauthentication is required; and transmit an acknowledgement (ACK) to the AUSF in response to the authentication trigger request.

The authentication manager 804 and/or other device components may be configured as or otherwise support a means for wireless communication and/or network signaling at a device (e.g., AMF/SEAF), including receiving a registration request from a user equipment (UE); transmitting an authentication request to an authentication server function (AUSF); receiving an authentication response from the AUSF, the authentication response comprising an indication of authentication success and at least one of an expiration time or a lifetime of authentication duration; and maintaining the at least one expiration time or the lifetime of the authentication duration along with a UE subscription permanent identifier (SUPI) configured to trigger a reauthentication.

Additionally, wireless communication and/or network signaling at the device includes any one or combination of: the method further comprising storing the at least one expiration time or the lifetime of authentication duration; and initiating to trigger the reauthentication of the UE based at least in part on the at least one expiration time or the lifetime of the authentication duration. The method further comprising transmitting the at least one expiration time or lifetime of authentication duration to a target access and mobility management function (AMF) in response to receiving a handover required message, the target AMF configured to store the at least one expiration time or the lifetime of authentication duration along with the SUPI and UE context, usable to invoke the reauthentication. The method further comprising receiving an authentication trigger request from the AUSF to initiate reauthentication, the authentication trigger request comprising one or more of a SUPI or an indication that reauthentication is required; and transmitting an acknowledgement (ACK) to the AUSF in response to the authentication trigger request.

Further, the authentication manager 804 and/or other device components may be configured as or otherwise support an apparatus, including a transceiver; a processor coupled to the transceiver, the processor and the transceiver configured to cause the apparatus to: receive a data request for authentication data from an authentication server function (AUSF); transmit the authentication data to the AUSF for primary authentication; receive an authentication trigger request from the AUSF, the authentication trigger request comprising one or more of a user equipment (UE) subscription permanent identifier (SUPI), an indication that reauthentication is required, or an indication as to a cause of the authentication trigger request; and transmit an ACK to the AUSF in response to the authentication trigger request.

Additionally, the apparatus (e.g., a device, a UDM) includes any one or combination of: the authentication data transmitted to the AUSF comprises one or more of an authentication vector (AV), an expiry time of the AV, an expiry time of the primary authentication, the SUPI, an AKMA indication, or a routing indicator. The cause of the authentication trigger request comprises one or more of an expired AUSF key (K_{AUSF}), a counter wrap expiry indication, or an authentication lifetime expired indication. The processor is configured to cause the apparatus to determine whether the authentication trigger request is valid based at least in part on an expiration indication of at least one of expiry time or a lifetime duration as configured for an AV. The processor is configured to cause the apparatus to determine whether the authentication trigger request is valid based at least in part on an expiration indication of at least one of expiry time, a lifetime duration for primary authentication associated with the SUPI, or a lifetime duration for primary reauthentication associated with the SUPI. The processor is configured to cause the apparatus to store at least one of steering of roaming (SoR) data or user equipment (UE) parameter update (UPU) data until a successful primary reauthentication is completed, and reinitiate at least one of the SOR or the UPU. The processor is configured to cause the apparatus to store an authentication status of the UE and set an authentication expiration time for the UE. The processor and the transceiver are configured to cause the apparatus to transmit an authentication result confirmation response to the AUSF, the authentication result confirmation response comprising at least one of an expiry time or lifetime duration associated with primary authentication. The processor and the transceiver are configured to cause the apparatus to transmit a registration response result to an access and mobility management function (AMF), the registration response result comprising at least one of an expiry time or lifetime duration associated with primary authentication.

The authentication manager 804 and/or other device components may be configured as or otherwise support a means for wireless communication and/or network signaling at a device (e.g., UDM), including receiving a data request for authentication data from an authentication server function (AUSF); transmitting the authentication data to the AUSF for primary authentication; receiving an authentication trigger request from the AUSF, the authentication trigger request comprising one or more of a user equipment (UE) subscription permanent identifier (SUPI), an indication that reauthentication is required, or an indication as to a cause of the authentication trigger request; and transmitting an acknowledgement (ACK) to the AUSF in response to the authentication trigger request.

Additionally, wireless communication and/or network signaling at the device includes any one or combination of: the authentication data transmitted to the AUSF comprises one or more of an authentication vector (AV), an expiry time of the AV, an expiry time of the primary authentication, the SUPI, an AKMA indication, or a routing indicator. The cause of the authentication trigger request comprises one or more of an expired AUSF key (K_{AUSF}), a counter wrap expiry indication, or an authentication lifetime expired indication. The method further comprising determining whether the authentication trigger request is valid based at least in part on an expiration indication of at least one of expiry time or a lifetime duration as configured for an AV. The method further comprising determining whether the authentication trigger request is valid based at least in part on an expiration indication of at least one of expiry time, a lifetime duration for primary authentication associated with the SUPI, or a lifetime duration for primary reauthentication associated with the SUPI. The method further comprising storing at least one of steering of roaming (SoR) data or user equipment (UE) parameter update (UPU) data until a successful primary reauthentication is completed, and reinitiate at least one of the SOR or the UPU. The method further comprising storing an authentication status of the UE and set an authentication expiration time for the UE. The method further comprising transmitting an authentication result confirmation response to the AUSF, the authentication result confirmation response comprising at least one of an expiry time or lifetime duration associated with primary authentication. The method further comprising transmitting a registration response result to an access and mobility management function (AMF), the registration response result comprising at least one of an expiry time or lifetime duration associated with primary authentication.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

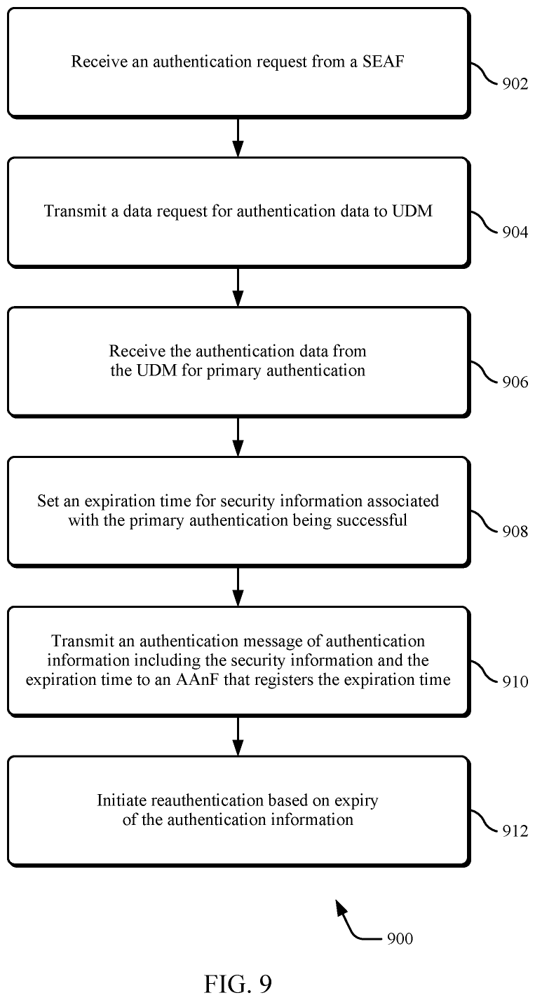

FIG. 9 illustrates a flowchart of a method 900 that supports network initiated primary authentication in accordance with aspects of the present disclosure. The operations of the method 900 may be implemented and performed by a device or its components, such as a device implemented as an AUSF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving an authentication request from a SEAF. The operations of 902 may be performed in accordance with examples as described herein. In some implementations, aspects of the operations of 902 may be performed by a device as described with reference to FIG. 1.

At 904, the method may include transmitting a data request for authentication data to UDM. The operations of 904 may be performed in accordance with examples as described herein. In some implementations, aspects of the operations of 904 may be performed by a device as described with reference to FIG. 1.

At 906, the method may include receiving the authentication data from the UDM for primary authentication. The operations of 906 may be performed in accordance with examples as described herein. In some implementations, aspects of the operations of 906 may be performed by a device as described with reference to FIG. 1.

At 908, the method may include setting an expiration time for security information associated with the primary authentication being successful. The operations of 908 may be performed in accordance with examples as described herein. In some implementations, aspects of the operations of 908 may be performed by a device as described with reference to FIG. 1.

At 910, the method may include transmitting an authentication message of authentication information including the security information and the expiration time to an AAnF that registers the expiration time. The operations of 910 may be performed in accordance with examples as described herein. In some implementations, aspects of the operations of 910 may be performed by a device as described with reference to FIG. 1.

At 912, the method may include initiating reauthentication based on expiry of the authentication information. The operations of 912 may be performed in accordance with examples as described herein. In some implementations, aspects of the operations of 912 may be performed by a device as described with reference to FIG. 1.

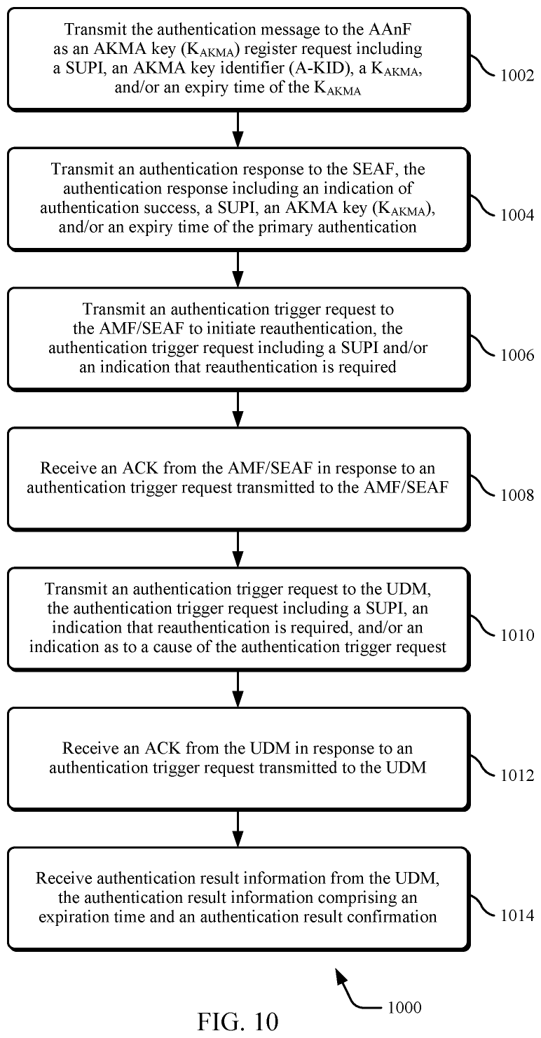

FIG. 10 illustrates a flowchart of a method 1000 that supports network initiated primary authentication in accordance with aspects of the present disclosure. The operations of the method 1000 may be implemented and performed by a device or its components, such as a device implemented as an AUSF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include transmitting the authentication message to the AAnF as an AKMA key (K_{AKMA}) register request including a SUPI, an AKMA key identifier (A-KID), a K_{AKMA}, and/or an expiry time of the K_{AKMA}. The operations of 1002 may be performed in accordance with examples as described herein. In some implementations, aspects of the operations of 1002 may be performed by a device as described with reference to FIG. 1.

At 1004, the method may include transmitting an authentication response to the SEAF, the authentication response including an indication of authentication success, a SUPI, an AKMA key (K_{AKMA}), and/or an expiry time of the primary authentication. The operations of 1004 may be performed in accordance with examples as described herein. In some implementations, aspects of the operations of 1004 may be performed by a device as described with reference to FIG. 1.

At 1006, the method may include transmitting an authentication trigger request to the AMF/SEAF to initiate reauthentication, the authentication trigger request including a SUPI and/or an indication that reauthentication is required. The operations of 1006 may be performed in accordance with examples as described herein. In some implementations, aspects of the operations of 1006 may be performed by a device as described with reference to FIG. 1.

At 1008, the method may include receiving an ACK from the AMF/SEAF in response to an authentication trigger request transmitted to the AMF/SEAF. The operations of 1008 may be performed in accordance with examples as described herein. In some implementations, aspects of the operations of 1008 may be performed by a device as described with reference to FIG. 1.

At 1010, the method may include transmitting an authentication trigger request to the UDM, the authentication trigger request including a SUPI, an indication that reauthentication is required, and/or an indication as to a cause of the authentication trigger request. The operations of 1010 may be performed in accordance with examples as described herein. In some implementations, aspects of the operations of 1010 may be performed by a device as described with reference to FIG. 1.

At 1012, the method may include receiving an ACK from the UDM in response to an authentication trigger request transmitted to the UDM. The operations of 1012 may be performed in accordance with examples as described herein. In some implementations, aspects of the operations of 1012 may be performed by a device as described with reference to FIG. 1.

At 1014, the method may include receiving authentication result information from the UDM, the authentication result information comprising an expiration time and an authentication result confirmation. The operations of 1014 may be performed in accordance with examples as described herein. In some implementations, aspects of the operations of 1014 may be performed by a device as described with reference to FIG. 1.

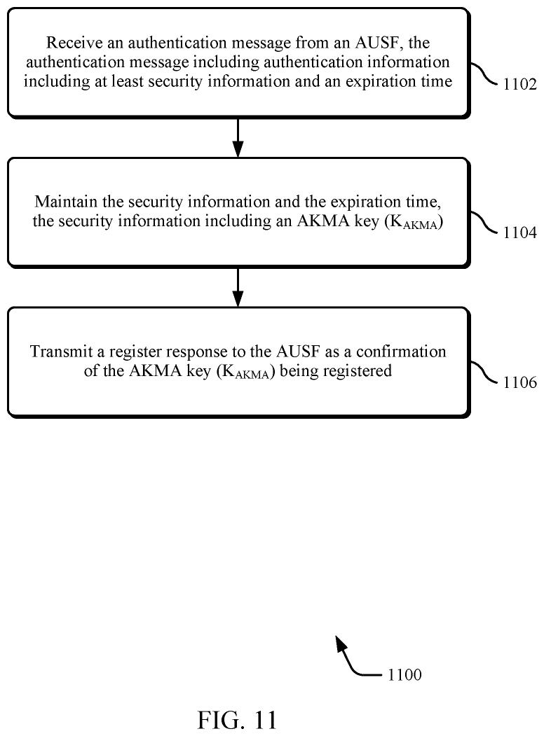

FIG. 11 illustrates a flowchart of a method 1100 that supports network initiated primary authentication in accordance with aspects of the present disclosure. The operations of the method 1100 may be implemented and performed by a device or its components, such as a device implemented as an AAnF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving an authentication message from an AUSF, the authentication message including authentication information including at least security information and an expiration time. The operations of 1102 may be performed in accordance with examples as described herein. In some implementations, aspects of the operations of 1102 may be performed by a device as described with reference to FIG. 1.

At 1104, the method may include maintaining the security information and the expiration time, the security information including an AKMA key (K_{AKMA}). The operations of 1104 may be performed in accordance with examples as described herein. In some implementations, aspects of the operations of 1104 may be performed by a device as described with reference to FIG. 1.

At 1106, the method may include transmitting a register response to the AUSF as a confirmation of the AKMA key (K_{AKMA}) being registered. The operations of 1106 may be performed in accordance with examples as described herein. In some implementations, aspects of the operations of 1106 may be performed by a device as described with reference to FIG. 1.

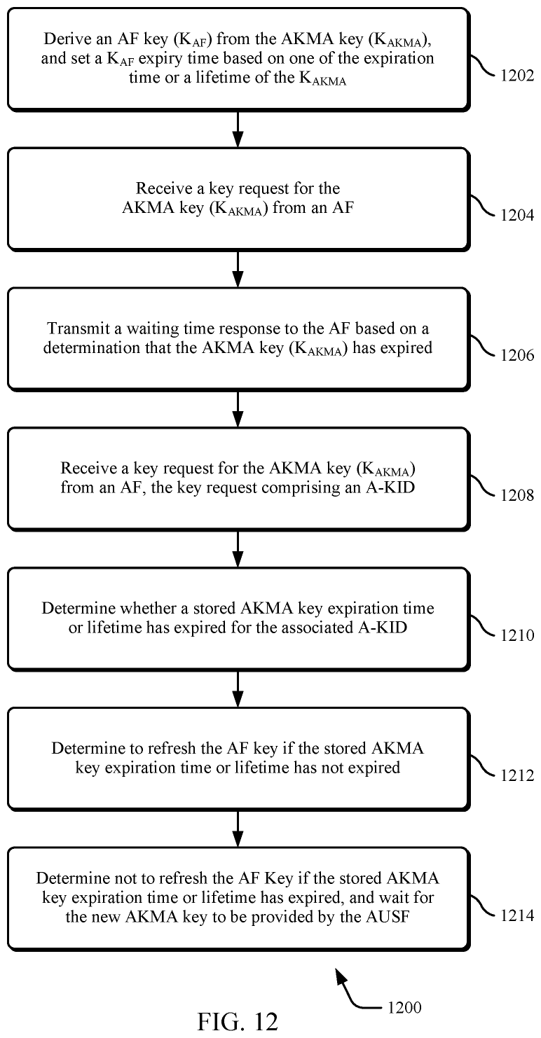

FIG. 12 illustrates a flowchart of a method 1200 that supports network initiated primary authentication in accordance with aspects of the present disclosure. The operations of the method 1200 may be implemented and performed by a device or its components, such as a device implemented as an AAnF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include deriving an AF key (K_{AF}) from the AKMA key (K_{AKMA}), and set a K_{AF} expiry time based on one of the expiration time or a lifetime of the K_{AKMA}. The operations of 1202 may be performed in accordance with examples as described herein. In some implementations, aspects of the operations of 1202 may be performed by a device as described with reference to FIG. 1.

At 1204, the method may include receiving a key request for the AKMA key (K_{AKMA}) from an AF. The operations of 1204 may be performed in accordance with examples as described herein. In some implementations, aspects of the operations of 1204 may be performed by a device as described with reference to FIG. 1.

At 1206, the method may include transmitting a waiting time response to the AF based on a determination that the AKMA key (K_{AKMA}) has expired. The operations of 1206 may be performed in accordance with examples as described herein. In some implementations, aspects of the operations of 1206 may be performed by a device as described with reference to FIG. 1.

At 1208, the method may include receiving a key request for the AKMA key (K_{AKMA}) from an AF, the key request comprising an A-KID. The operations of 1208 may be performed in accordance with examples as described herein. In some implementations, aspects of the operations of 1208 may be performed by a device as described with reference to FIG. 1.

At 1210, the method may include determining whether a stored AKMA key expiration time or lifetime has expired for the associated A-KID. The operations of 1210 may be performed in accordance with examples as described herein. In some implementations, aspects of the operations of 1210 may be performed by a device as described with reference to FIG. 1.

At 1212, the method may include determining to refresh the AF key if the stored AKMA key expiration time or lifetime has not expired. The operations of 1212 may be performed in accordance with examples as described herein. In some implementations, aspects of the operations of 1212 may be performed by a device as described with reference to FIG. 1.

At 1214, the method may include determining not to refresh the AF Key if the stored AKMA key expiration time or lifetime has expired, and wait for the new AKMA key to be provided by the AUSF. The operations of 1214 may be performed in accordance with examples as described herein. In some implementations, aspects of the operations of 1214 may be performed by a device as described with reference to FIG. 1.

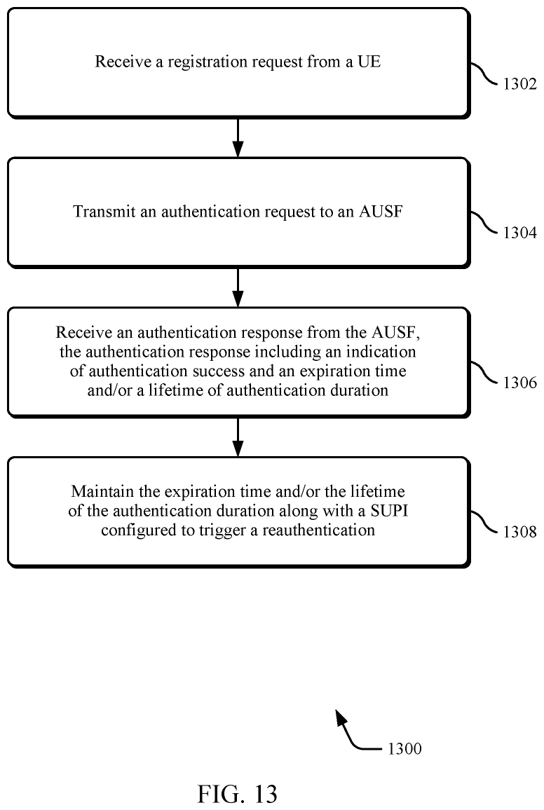

FIG. 13 illustrates a flowchart of a method 1300 that supports network initiated primary authentication in accordance with aspects of the present disclosure. The operations of the method 1300 may be implemented and performed by a device or its components, such as a device implemented as an AMF/SEAF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1302, the method may include receiving a registration request from a UE. The operations of 1302 may be performed in accordance with examples as described herein. In some implementations, aspects of the operations of 1302 may be performed by a device as described with reference to FIG. 1.

At 1304, the method may include transmitting an authentication request to an AUSF. The operations of 1304 may be performed in accordance with examples as described herein. In some implementations, aspects of the operations of 1304 may be performed by a device as described with reference to FIG. 1.

At 1306, the method may include receiving an authentication response from the AUSF, the authentication response including an indication of authentication success and an expiration time and/or a lifetime of authentication duration. The operations of 1306 may be performed in accordance with examples as described herein. In some implementations, aspects of the operations of 1306 may be performed by a device as described with reference to FIG. 1.

At 1308, the method may include maintaining the expiration time and/or the lifetime of the authentication duration along with a SUPI configured to trigger a reauthentication. The operations of 1308 may be performed in accordance with examples as described herein. In some implementations, aspects of the operations of 1308 may be performed by a device as described with reference to FIG. 1.

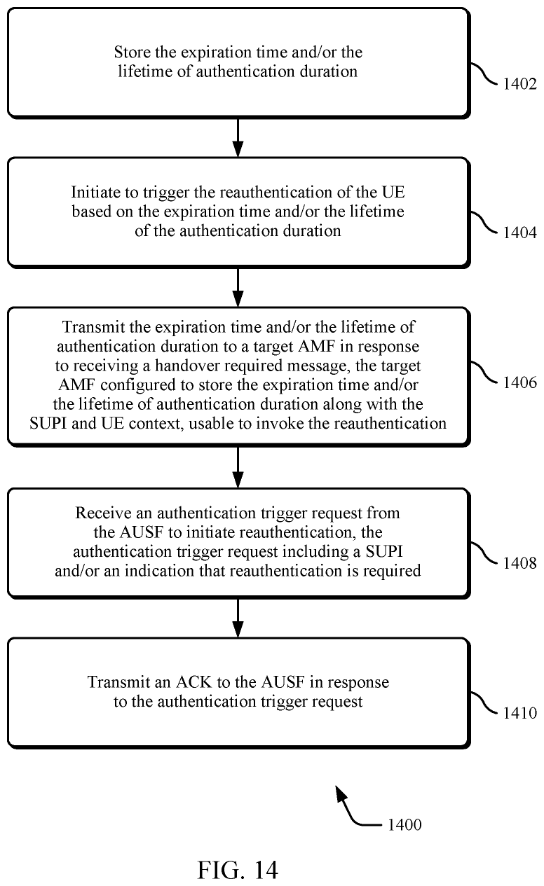

FIG. 14 illustrates a flowchart of a method 1400 that supports network initiated primary authentication in accordance with aspects of the present disclosure. The operations of the method 1400 may be implemented and performed by a device or its components, such as a device implemented as an AMF/SEAF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1402, the method may include storing the expiration time and/or the lifetime of authentication duration. The operations of 1402 may be performed in accordance with examples as described herein. In some implementations, aspects of the operations of 1402 may be performed by a device as described with reference to FIG. 1.

At 1404, the method may include initiating to trigger the reauthentication of the UE based on the expiration time and/or the lifetime of the authentication duration. The operations of 1404 may be performed in accordance with examples as described herein. In some implementations, aspects of the operations of 1404 may be performed by a device as described with reference to FIG. 1.

At 1406, the method may include transmitting the expiration time and/or the lifetime of authentication duration to a target AMF in response to receiving a handover required message, the target AMF configured to store the expiration time and/or the lifetime of authentication duration along with the SUPI and UE context, usable to invoke the reauthentication. The operations of 1406 may be performed in accordance with examples as described herein. In some implementations, aspects of the operations of 1406 may be performed by a device as described with reference to FIG. 1.

At 1408, the method may include receiving an authentication trigger request from the AUSF to initiate reauthentication, the authentication trigger request including a SUPI and/or an indication that reauthentication is required. The operations of 1408 may be performed in accordance with examples as described herein. In some implementations, aspects of the operations of 1408 may be performed by a device as described with reference to FIG. 1.

At 1410, the method may include transmitting an ACK to the AUSF in response to the authentication trigger request. The operations of 1410 may be performed in accordance with examples as described herein. In some implementations, aspects of the operations of 1410 may be performed by a device as described with reference to FIG. 1.

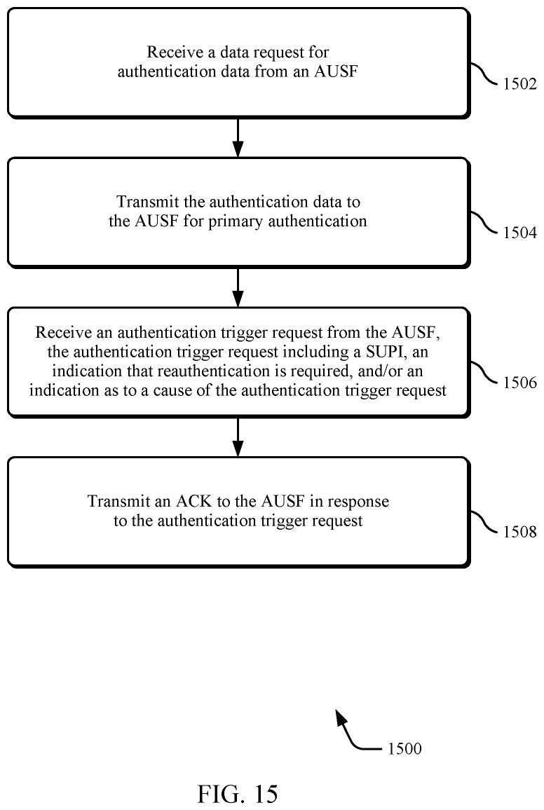

FIG. 15 illustrates a flowchart of a method 1500 that supports network initiated primary authentication in accordance with aspects of the present disclosure. The operations of the method 1500 may be implemented and performed by a device or its components, such as a device implemented as a UDM as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1502, the method may include receiving a data request for authentication data from an AUSF. The operations of 1502 may be performed in accordance with examples as described herein. In some implementations, aspects of the operations of 1502 may be performed by a device as described with reference to FIG. 1.

At 1504, the method may include transmitting the authentication data to the AUSF for primary authentication. The operations of 1504 may be performed in accordance with examples as described herein. In some implementations, aspects of the operations of 1504 may be performed by a device as described with reference to FIG. 1.

At 1506, the method may include receiving an authentication trigger request from the AUSF, the authentication trigger request including a SUPI, an indication that reauthentication is required, and/or an indication as to a cause of the authentication trigger request. The operations of 1506 may be performed in accordance with examples as described herein. In some implementations, aspects of the operations of 1506 may be performed by a device as described with reference to FIG. 1.

At 1508, the method may include transmitting an ACK to the AUSF in response to the authentication trigger request. The operations of 1508 may be performed in accordance with examples as described herein. In some implementations, aspects of the operations of 1508 may be performed by a device as described with reference to FIG. 1.

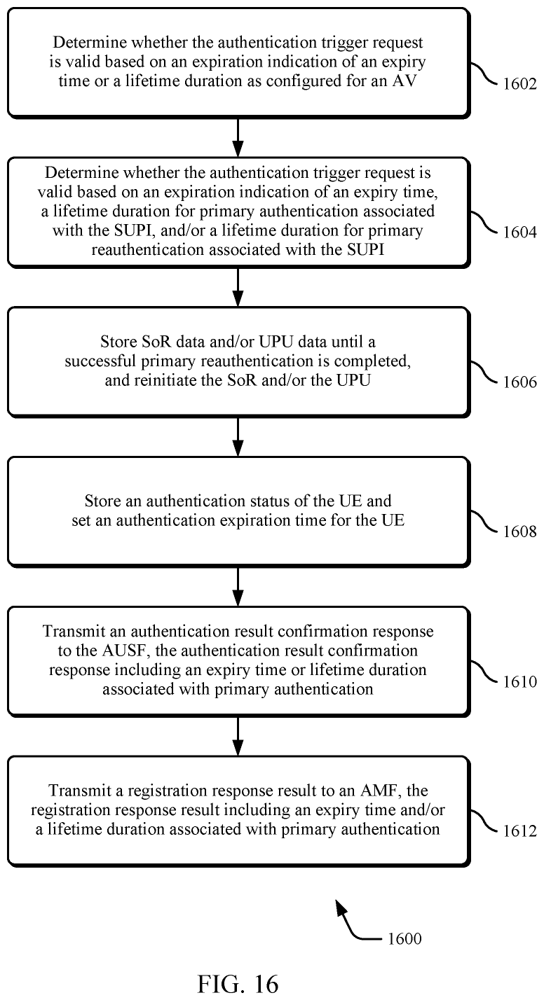

FIG. 16 illustrates a flowchart of a method 1600 that supports network initiated primary authentication in accordance with aspects of the present disclosure. The operations of the method 1600 may be implemented and performed by a device or its components, such as a device implemented as a UDM as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1602, the method may include determining whether the authentication trigger request is valid based on an expiration indication of an expiry time or a lifetime duration as configured for an AV. The operations of 1602 may be performed in accordance with examples as described herein. In some implementations, aspects of the operations of 1602 may be performed by a device as described with reference to FIG. 1.

At 1604, the method may include determining whether the authentication trigger request is valid based on an expiration indication of an expiry time, a lifetime duration for primary authentication associated with the SUPI, and/or a lifetime duration for primary reauthentication associated with the SUPI. The operations of 1604 may be performed in accordance with examples as described herein. In some implementations, aspects of the operations of 1604 may be performed by a device as described with reference to FIG. 1.

At 1606, the method may include storing SoR data and/or UPU data until a successful primary reauthentication is completed, and reinitiate the SoR and/or the UPU. The operations of 1606 may be performed in accordance with examples as described herein. In some implementations, aspects of the operations of 1606 may be performed by a device as described with reference to FIG. 1.

At 1608, the method may include storing an authentication status of the UE and set an authentication expiration time for the UE. The operations of 1608 may be performed in accordance with examples as described herein. In some implementations, aspects of the operations of 1608 may be performed by a device as described with reference to FIG. 1.

At 1610, the method may include transmitting an authentication result confirmation response to the AUSF, the authentication result confirmation response including an expiry time or lifetime duration associated with primary authentication. The operations of 1610 may be performed in accordance with examples as described herein. In some implementations, aspects of the operations of 1610 may be performed by a device as described with reference to FIG. 1.

At 1612, the method may include transmitting a registration response result to an AMF, the registration response result including an expiry time and/or a lifetime duration associated with primary authentication. The operations of 1612 may be performed in accordance with examples as described herein. In some implementations, aspects of the operations of 1612 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus, comprising:
a transceiver;
a processor coupled to the transceiver, the processor and the transceiver configured to cause the apparatus to:
set an expiration time for security information associated with primary authentication being successful;
receive an authentication trigger request from a network function with cause information;
determine to initiate reauthentication based on at least one of expiry of authentication information or the cause information; and
transmit an authentication message to at least one of a mobility management function (AMF) or a security anchor function (SEAF) to initiate the reauthentication.

2. The apparatus of claim 1, wherein the network function is a core network function (AUSF) and the cause information comprises at least one of a steering of roaming (SoR) counter wrap around, a SoR counter is about to wrap around indication, a user equipment (UE) parameter update (UPU) counter wrap around, or a UPU counter is about to wrap around indication, and the processor is configured to cause the apparatus to initiate the reauthentication based on the expiry of the SoR counter wrap around or the UPU counter wrap around.

3. The apparatus of claim 2, wherein:
the processor and the transceiver are configured to cause the apparatus to receive the authentication trigger request from the network function, the authentication trigger request comprising one or more of a subscription permanent identifier (SUPI), an indication that the reauthentication is required, or an indication as to a cause of the authentication trigger request; and
the cause of the authentication trigger request comprises one or more of, a SoR counter wrap around indication, the SoR counter is about to wrap around indication, a UPU counter wrap around indication, or the UPU counter is about to wrap around indication.

4. The apparatus of claim 1, wherein the processor is configured to cause the apparatus to initiate the reauthentication based on an authentication policy by a home network operator.

5. The apparatus of claim 1, wherein the security information comprises one or more of an authentication server function (AUSF) key (K_{AUSF}), an authentication and key management for applications (AKMA) key (K_{AKMA}), an authentication vector, a primary authentication status, or a primary authentication result.

6. The apparatus of claim 1, wherein authentication data provided from unified data management (UDM) to an authentication server function (AUSF) comprises one or more of an authentication vector (AV), an expiry time of the AV, an expiry time of the primary authentication, a subscription permanent identifier (SUPI), a key management for applications (AKMA) indication, or a routing indicator.

7. The apparatus of claim 1, wherein the processor and the transceiver are configured to cause the apparatus to transmit an authentication request to the AMF or the SEAF to initiate the reauthentication, the authentication request comprising one or more of a subscription permanent identifier (SUPI) or an indication that the reauthentication is required.

8. The apparatus of claim 1, wherein the processor and the transceiver are configured to cause the apparatus to receive an acknowledgement (ACK) from the AMF or the SEAF in response to an authentication trigger request transmitted to the AMF or the SEAF.

9. The apparatus of claim 8, wherein the ACK indicates one of an authentication success or an authentication failure.

10. The apparatus of claim 1, wherein the processor and the transceiver are configured to cause the apparatus to receive an acknowledgement (ACK) from a unified data management (UDM) in response to the authentication trigger request.

11. An apparatus, comprising:
a transceiver;
a processor coupled to the transceiver, the processor and the transceiver configured to cause the apparatus to:
receive an authentication message from an authentication server function (AUSF), the authentication message comprising authentication information including at least security information and an expiration time;
maintain the security information and the expiration time, the security information comprising at least an authentication and key management for applications (AKMA) key (K_{AKMA}); and
transmit a register response to the AUSF as a confirmation of the AKMA key (K_{AKMA}) being registered.

12. The apparatus of claim 11, wherein the authentication message is received from the AUSF as an AKMA key (K_{AKMA}) register request comprising one or more of a user equipment (UE) subscription permanent identifier (SUPI), an AKMA key identifier (A-KID), the K_{AKMA}, or an expiry time of the K_{AKMA}.

13. The apparatus of claim 11, wherein the processor is configured to cause the apparatus to derive an application function (AF) key (K_{AF}) from the AKMA key (K_{AKMA}), and set a K_{AF} expiry time based on one of the expiration time or a lifetime of the K_{AKMA}.

14. The apparatus of claim 11, wherein the processor and the transceiver are configured to cause the apparatus to:
receive a key request for the AKMA key (K_{AKMA}) from an application function (AF); and
transmit a waiting time response to the AF based at least in part on a determination that the AKMA key (K_{AKMA}) has expired.

15. An apparatus, comprising:
a transceiver;
a processor coupled to the transceiver, the processor and the transceiver configured to cause the apparatus to:
receive an authentication request from unified data management (UDM) to initiate reauthentication, an authentication message comprising one or more of a subscription permanent identifier (SUPI) or an indication that reauthentication is required; and
transmit an acknowledgement (ACK) to the UDM in response to an authentication response.

16. The apparatus of claim 15, wherein the ACK indicates one of an authentication success or an authentication failure.

17. An apparatus, comprising:
a transceiver;
a processor coupled to the transceiver, the processor and the transceiver configured to cause the apparatus to:
set an expiration time for security information associated with primary authentication being successful; and
transmit an authentication message of authentication information comprising at least the security information and the expiration time to an authentication and key management for applications (AKMA) anchor function (AAnF) that registers the expiration time, the authentication message transmitted to the AAnF as an AKMA key (K_{AKMA}) register request comprising one or more of a user equipment (UE) subscription permanent identifier (SUPI), an AKMA key identifier (A-KID), a K_{AKMA}, or an expiry time of the K_{AKMA}; and
determine to initiate reauthentication based at least in part on expiry of the authentication information.

18. The apparatus of claim 17, wherein the authentication information comprises at least one of a steering of roaming (SoR) counter wrap around, a SoR counter is about to wrap around indication, a user equipment (UE) parameter update (UPU) counter wrap around, or a UPU counter is about to wrap around indication, and the processor is configured to cause the apparatus to initiate the reauthentication based on the expiry of the SoR counter wrap around or the UPU counter wrap around.

19. The apparatus of claim 17, wherein the security information comprises one or more of an authentication server function (AUSF) key (K_{AUSF}), the K_{AKMA}, an authentication vector, a primary authentication status, or a primary authentication result.

20. The apparatus of claim 17, wherein the processor and the transceiver are configured to cause the apparatus to receive authentication data for the primary authentication, the authentication data including one or more of an authentication vector (AV), an expiry time of the AV, an expiry time of the primary authentication, a subscription permanent identifier (SUPI), an AKMA indication, or a routing indicator.
